(19) United States
(12) Patent Application Publication
(10) Pub. No.: US 2026/0217481 A1
(43) Pub. Date: Jul. 30, 2026

(54) SYSTEMS AND METHODS FOR OBJECT PROCESSING WITH VACUUM ASSISTED LIFTING

(71) Applicant: Berkshire Grey Operating Company, Inc., Bedford, MA (US)

(72) Inventors: Jeffrey Ian LIPTON, Sharon, MA (US); Peter Gerard KELLY, Boston, MA (US)

(21) Appl. No.: 19/456,720

(22) Filed: Jan. 22, 2026

Related U.S. Application Data
(60) Provisional application No. 63/749,195, filed on Jan. 24, 2025.

(51) Int. Cl. B65G 47/91

(52) U.S. Cl. CPC B65G 47/91

(57) ABSTRACT

Disclosed are systems and methods for object processing using programmable motion devices with vacuum-assisted lifting. The invention integrates high-flow vacuum technology with end-effectors to securely grasp objects of varying sizes and weights, even under imperfect seals. A lift-assist mechanism employing vacuum-actuated bellows provides supplemental lifting force for heavy objects without compromising robotic agility. Multiple configurations are detailed, including gantry-mounted bellows, telescoping booms, and cable-based assist systems, each designed to maintain throughput while reducing mechanical strain. Control strategies leverage force/torque sensors and dynamic vacuum modulation to optimize lifting performance. The approach enables efficient handling in applications such as e-commerce order fulfillment, automated storage, and material sortation, offering improved adaptability, safety, and operational efficiency.

### PRIORITY

This application claims priority to U.S. Provisional Patent Application No. 63/749,195 filed January 24, 2025, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear). Further, in certain applications it may be desired to place an object at a destination in a required orientation or pose, particularly with respect to an environment such as a container being packed by a robotic system.

Many end-effectors employ vacuum, or negative pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object using the vacuum, or negative pressure.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are more adapted to a specific type or class of object and therefore less effective at acquiring and moving a wide variety of objects.

Such applications in which a robotic system needs to accurately process a wide variety of sizes of objects relative to an environment include, for example, packing multi-unit e-commerce orders into a container, packing a single unit into an automated bagging system, packing or consolidating containers used in an automated storage and retrieval system (AS/RS), and scanning objects in front of scanners such as barcode scanners or RFID scanners.

Vacuum end-effectors, however, may be limited in their ability to acquire objects of a wide variety of sizes and weights, such as if the objects being processed include objects that may be too heavy for a programmable motion device to safely or effectively lift without damage to either the programmable motion device or the object.

There remains a need therefore, for systems and methods for more efficiently and effectively packing and manipulating objects by efficiently acquiring objects of a wide variety of sizes and weights without adversely impacting throughput.

### SUMMARY

In accordance with an aspect, the invention provides an object processing system with a programmable motion device having an end-effector using high flow vacuum to grasp and move an object within a workspace. The system has an anchor positioned above the workspace with a lifting bellows having a first end and a second end, the first end connected to the anchor, the second end connected to the end-effector. The lifting bellows has a high flow vacuum source supply and a valve between the lifting bellows and the high flow vacuum source supply to regulate an amount of lift provided to the end-effector as the lifting bellows contracts from the high flow vacuum source supply.

In accordance with another aspect, the invention provides an object processing system with a programmable motion device having an end-effector using high flow vacuum to grasp and move an object within a workspace. A lift assistance system having a vertical support of a base and an overhead beam, a lifting bellows having a first end and a second end, the first end connected to the base and the second end connected to a lifting cable, the lifting bellows closed at the second end, and a high flow vacuum source fluidically connected to the lifting bellows at the first end. The high flow vacuum uses a valve to modulate the amount of vacuum provided to the lifting bellows, with at least two pulleys attached to the overhead beam, the pulleys supporting the lifting cable and the lifting cable attached to the end-effector to provide lift assistance to the programmable motion device.

In accordance with a further aspect, the invention provides a method of moving heavy objects with a programmable motion device by providing an end-effector with the programmable motion device, the end-effector being adapted to grasp the heavy object, providing a high flow vacuum from a high flow vacuum source to a lifting bellows, the lifting bellows providing a lift assistance to the programmable motion device, and moving the object using the programmable motion device.

### BRIEF DESCRIPTION OF THE DRAWINGS

The following description may be further understood with reference to the accompanying drawings in which:

FIG. 1 shows an illustrative diagrammatic view of an object processing system including a programmable motion device with an end-effector system in accordance with an aspect of the present invention that includes a directly coupled bellows;

FIGS. 2A and 2B shows illustrative diagrammatic side views of the object processing system of FIG. 1 (FIG. 2A) and an alternate object processing system that includes a telescoping boom assembly (FIG. 2B);

FIG. 3 shows an illustrative diagrammatic enlarged rear view of the programmable motion device of the object processing system of FIG. 1;

FIG. 4 shows an illustrative diagrammatic further enlarged view of the end-effector of the programmable motion device of FIG. 1;

FIG. 5 shows an illustrative diagrammatic view of the input area of the object processing system of FIG. 1, wherein the object being held has been moved from the location at which it was positioned in FIG. 1;

FIG. 6 shows an illustrative diagrammatic view of a portion of the end-effector system of FIG. 1 showing an enlarged view of the boom roller system;

FIG. 7 shows an illustrative diagrammatic view of a portion of the end-effector system of FIG. 1 showing an enlarged view of the upper beam roller system;

FIG. 8 shows an illustrative diagrammatic view of a portion of the end-effector system of FIG. 1 showing an enlarged view of the lower beam roller system;

FIG. 9 shows an illustrative diagrammatic underside elevated view of the end-effector of the object processing system of FIG. 1;

FIG. 10 shows an illustrative diagrammatic side view of the end-effector coupling system in accordance with a further aspect of the invention that couples the end-effector to the programmable motion device via a force torque sensor;

FIGS. 11A and 11B show illustrative diagrammatic upper elevational cut-away views of the vacuum valve assembly of the system of FIG. 1 showing the valve to the bellows closed (FIG. 11A) and showing the valve to the bellows open (FIG. 11B);

FIGS. 12A and 12B show illustrative diagrammatic front views of the end-effector of the system of FIG. 1 showing a relatively light object being grasped (FIG. 12A) and showing a relatively heavy object being grasped (FIG. 12B);

FIGS. 13A and 13B show illustrative diagrammatic underside elevational views of an end-effector in accordance with another aspect of the invention that is used in connection with a cup-changing rack, showing end-effector with a first vacuum cup (FIG. 13A), and showing the end-effector exchanging the first vacuum cup with a second vacuum cup (FIG. 13B);

FIG. 14 shows an illustrative diagrammatic view of another object processing system including a programmable motion device with an end-effector system in accordance with another aspect of the present invention that includes a remotely coupled bellows;

FIG. 15 shows an illustrative diagrammatic side view of the object processing system of FIG. 14;

FIGS. 16 shows an illustrative diagrammatic enlarged view of the programmable motion device of the object processing system of FIG. 14;

FIGS. 17 shows an illustrative diagrammatic enlarged front view of the end-effector of the programmable motion device of FIG. 14;

FIGS. 18A and 18B show illustrative diagrammatic views of a magnetic coupling between the end-effector and the bellows cable in the object processing system of FIG. 14, showing the magnetic coupling not attached (FIG. 18A) and attached (FIG. 18B);

FIG. 19 shows an illustrative diagrammatic side view of the front boom of the object processing system of FIG. 14 showing a portion of the bellows cable;

FIG. 20 shows an illustrative diagrammatic side view of the rear boom of the object processing system of FIG. 14 showing another portion of the bellows cable;

FIGS. 21A and 21B show illustrative diagrammatic views of a boom tower translation system of the object processing system of FIG. 14, showing the base of the boom tower in a first position (FIG. 21A) and in a second position (FIG. 21B);

FIGS. 22A and 22B show illustrative diagrammatic views of the bellows vacuum source and control system, showing the bellows source and control system as mounted in the lower rear boom (FIG. 22A) and showing a cut-away view of the bellows control valve (FIG. 22B);

FIGS. 23A and 23B show illustrative diagrammatic front views of the end-effector of the system of FIG. 14 showing a relatively light object being grasped (FIG. 23A) and showing a relatively heavy object being grasped (FIG. 23B);

FIGS. 24A and 24B show illustrative diagrammatic underside elevational views of an end-effector in accordance with a further aspect of the invention that is used in connection with a cup-changing rack, showing end-effector with a first vacuum cup (FIG. 24A), and

showing the end-effector exchanging the first vacuum cup with a second vacuum cup (FIG. 24B);

FIGS. 25A and 25B show illustrative diagrammatic views of the programmable motion device of the system of FIG. 14, showing the programmable motion device with lift assist in a first position (FIG. 25A) and having moved with a load to a second position (FIG. 25B);

FIG. 26 shows an illustrative diagrammatic view of a portion of an end-effector used in accordance with certain aspects of the present invention with a portion of the end-effector housing removed, showing a yawing power assembly;

FIG. 27 shows an illustrative diagrammatic view of the object processing system of FIG. 14 showing the programmable motion device having placed an object;

FIG. 28 shows an illustrative diagrammatic view of an object processing system including a programmable motion device with an end-effector system in accordance with an aspect of the present invention that includes a remotely coupled bellows and a single vacuum source;

FIG. 29 shows an illustrative diagrammatic side view of the object processing system of FIG. 28;

FIGS. 30A and 30B show illustrative diagrammatic side cut-away views of the vacuum valve assembly of the system of FIG. 28 showing the valve to the bellows closed (FIG. 30A) and showing the valve to the bellows open (FIG. 30B);

FIG. 31 shows an illustrative diagrammatic view of another object processing system including a programmable motion device with an end-effector system in accordance with another aspect of the present invention that includes a remotely coupled bellows and a boom that traverses a single direction gantry;

FIG. 32 shows an illustrative diagrammatic side view of the object processing system of FIG. 31;

FIG. 33 shows an illustrative diagrammatic front view of the object processing system of FIG. 31 with the programmable motion device and the boom tower having moved;

FIGS. 34A and 34B show illustrative diagrammatic views of a boom tower translation system of the object processing system of FIG. 31, showing the base of the boom tower in a first position (FIG. 34A) and in a second position (FIG. 34B);

FIG. 35 shows an illustrative diagrammatic view of a further object processing system including a programmable motion device with an end-effector system in accordance with another aspect of the present invention that includes a remotely coupled bellows and a loop cable system;

FIG. 36 shows an illustrative diagrammatic side view of the object processing system of FIG. 35;

FIG. 37 shows an illustrative diagrammatic view of the loop cable system of the object processing system of FIG. 31;

FIG. 38 shows an illustrative diagrammatic enlarged view of the end-effector of the programmable motion device of the object processing system of FIG. 31;

FIGS. 39A - 39C show illustrative diagrammatic views of the programmable motion device of the system of FIG. 31 having moved from a first position (FIG. 39A), to a second position (FIG. 39B), and to a third position (FIG. 39C); and

FIG. 40 shows an illustrative diagrammatic functional view of the operational control system in accordance with an aspect of the present invention.

The drawings are shown for illustrative purposes only.

### DETAILED DESCRIPTION

In accordance with various aspects, the invention provides an end-effector system for programmable motion devices (e.g., robotic systems) that provides high flow vacuum to grasp objects of widely varying weights. High flow vacuum is a powerful, continuous airflow provided by blowers or air amplifiers that create an attachment force of an object to an end-effector even with an imperfect seal between the end-effector and the object. In a conventional high vacuum system, a slight leak due to an imperfect seal between the end-effector and the object can overwhelm the capacity of the vacuum pump and effectively reduce the attachment force. In a high flow vacuum system, the vacuum pressure created is less important than the capacity of the blower to extract air from the end-effector to create and maintain the attachment force. The high flow vacuum is provided at an end-effector vacuum applicator of the robotic system, and the vacuum applicator is coupled to a high flow vacuum system. The vacuum applicator is attached to an applicator attachment portion, which is in turn attached to an arm attachment portion that is attached to an articulated arm of the robotic system. The vacuum applicator may be a surface with vacuum apertures or may be a vacuum cup such as for example a vacuum cup that is formed of a flexible cup bellows.

The end-effector system of certain aspects of the invention includes a lift bellows that may be any of attached to the end-effector directly or may be attached to the end-effector remotely, for example by a cable system. The lift bellows provides that the end-effector system may be able to selectively engage the lift bellows to provide additional lift to assist in lifting heavy objects. The lift bellows may be arranged (as discussed in more detail below in accordance with various aspects of the invention) to provide lifting assistance when needed but also to not inhibit movement of the programmable motion device.

In particular, while gripping forces of certain vacuum grippers are able to securely hold a tight grasp on a heavy object, the programmable motion device (such as a robotic arm) may be unable to withstand the weight of the object. For example, active joints of a highly precise robotic system may have maximum weight (load) values lower than a maximum gripping force that may be applied at a vacuum gripper. If it is determined that an object has a mass that will exceed a maximum weight capacity of a robotic arm, the system may either route the object to a different processing station that includes a different robotic arm of increased size and torque, or the robotic arm may be swapped out with a different robotic arm of increased size and torque.

Applicant has discovered that a vacuum lifting device may be integrated into an end-effector system in such a way that the vacuum lifting device is available when needed but does not inhibit or restrict the use of the programmable motion device with the end-effector, even when exchanging vacuum cups.

An important consideration is the size of the vacuum lift system. The anchor or upper vertical support for a vacuum lift system must be positioned over the gripper and arm to assist in lift. The vacuum bellows generally contract by 50% of their range of motion. This means that a one-meter lift requires two meters of vertical clearance for the bellows plus the thickness of the bellows. This increase in height both moves any sensors farther from the robots workspace and increase the overall size of the cell. Applicant has discovered that a vacuum lift system may be incorporated into a programmable motion system with a vacuum cup such that vacuum lift assist may be used only when needed, and that may have a minimum thickness for passing between a robot and any caging or static sensors above the robot workspace.

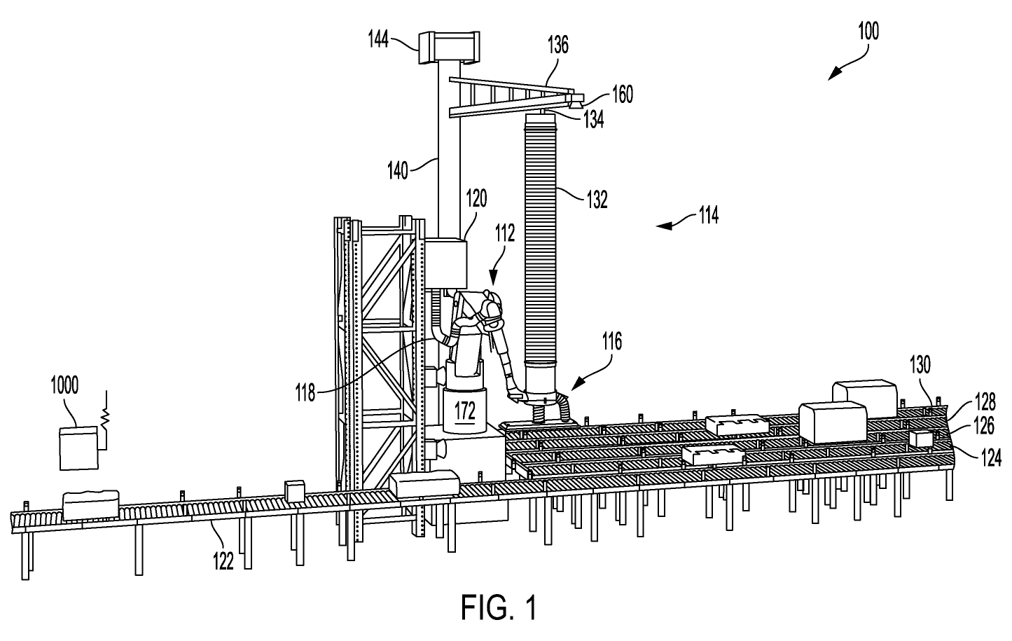

With reference to FIG. 1, an object processing system 100 in accordance with an aspect of the present invention includes a programmable motion device 112 and a vacuum lifting system 114. The programmable motion device 112 and the vacuum lifting system 114 are integrated together at a vacuum lift assist end-effector system 116 that is coupled via a vacuum hose 118 to a high flow vacuum source 120. The high flow vacuum source 120 may, for example, provide at the vacuum lift assist end-effector system 116 an air flow of at least about 100 cubic feet per minute, and a vacuum pressure of no more than about 100,000 Pascals below atmospheric, or no more than about 85,000 Pascals below atmospheric, or no more than about 65,000 Pascals below atmospheric. Objects to be processed are provided to the programmable motion device 112 on an in-feed conveyor 122, and are provided to any of first output conveyor 124, second output conveyor 126, third output conveyor 128 or fourth output conveyor 130 by the programmable motion device 112. One skilled in the art would appreciate that the object processing performed by the programmable motion device 112 represented by moving an object from the input conveyor 122 to any one of the output conveyors can be applied to any number of object processing tasks of a programmable motion device within the scope and spirit of the claimed invention. Object processing tasks can include palletizing objects and materials, sorting of objects, order fulfillment, and decanting of objects or materials, without limitation. The vacuum lifting system 114 includes an elongated bellows 132 suspended from an anchor, shown as a trolley 134 that rides within a track in a boom 136 (as further shown in FIG. 6). The boom 136 is mounted on a gantry crane system 138 that includes a tower 140 that freely rotates within lower tower bearing 142 and upper tower bearing 144.

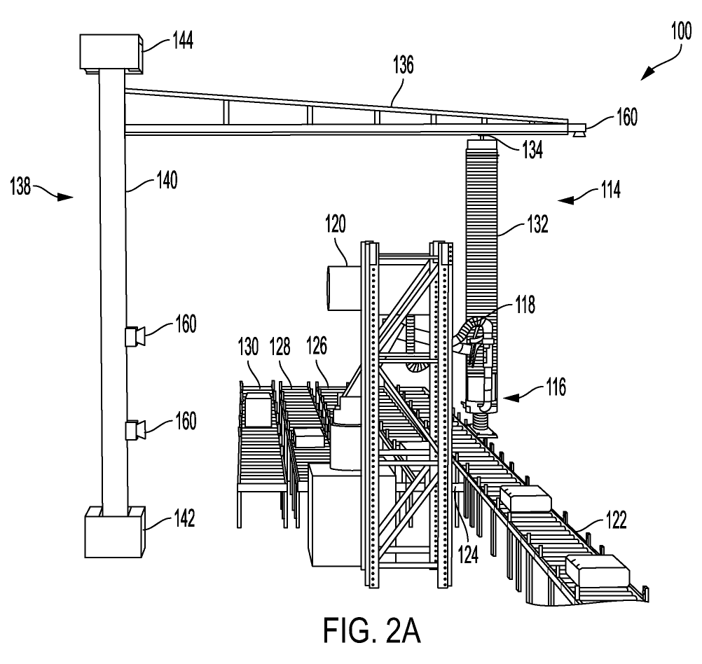

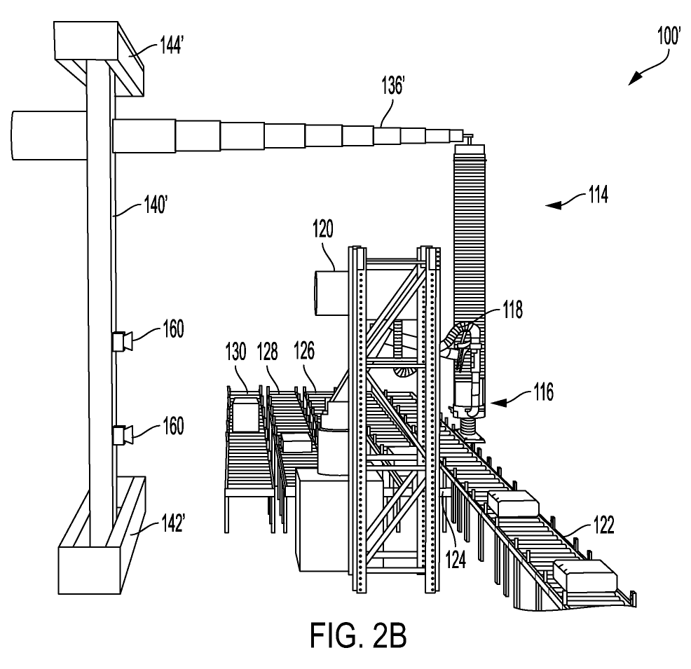

In accordance with an aspect of the invention, with continued reference to FIG. 1 and with reference to FIG. 2A, the trolley 134 rides freely within the track in the boom, and the tower 140 rotates freely within the lower and upper tower bearings 142, 144. This permits the bellows 132 to be anchored from above and remain in position above the vacuum lift assist end-effector system 116 while the programmable motion device 112 moves within the work environment. In accordance with further aspects of the invention, any or each of the trolley 134 and the tower 140 within the lower and upper tower bearings 142, 144 may be actively driven in concert with the movements of the programmable motion device 112 to provide that the bellows remain anchored and above the vacuum lift assist end-effector system 116 while the programmable motion device 112 moves within the work environment.

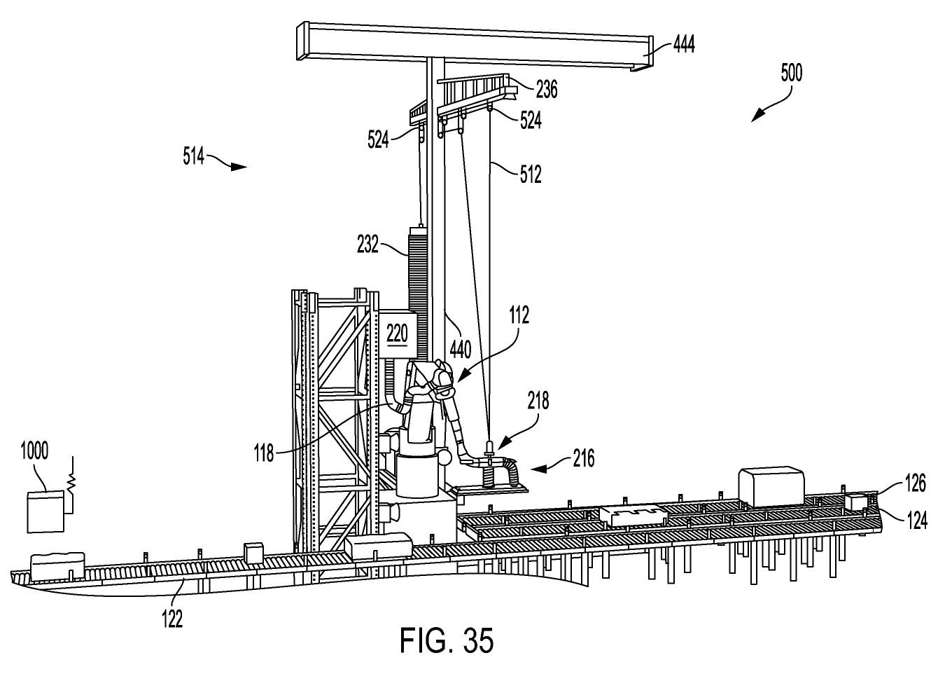

In accordance with further aspects of the present invention an object processing system 100’ in accordance with another aspect of the present invention may include a telescoping boom 136’ in place of the boom 136 and the tower 140’ in place of the tower 140 of FIGS. 1 and 2A as shown in FIG. 2B. In particular, the telescoping boom 136’ is controlled (together with lower and upper stages 142’, 144’) to maintain the bellows 132 to be anchored from above and positioned over the end-effector system 116. The operation of the lower and upper stages 142’, 144’ is the same as the operation of lower and upper stages 442, 444 discussed below with regard to FIGS. 35 - 39C. The lower and upper stages 142’, 144’ each include a movable stage of slide rails or tracks that permit motion in one dimension.

In accordance with an aspect of the invention, the vacuum flow path is diverted directly from the vacuum source 120 into the decoupled tube of a high flow suction gripper through vacuum hose 118. This high flow suction gripper has an attachment at the end that allows cups to be mechanically attached and detached for various sized applications in accordance with certain aspects. The decoupled device can slide up and down with respect to the mount 168 on the programmable motion device 112. The drawn vacuum goes from there into either the cup and then into the bellows or is diverted and split between the bellows and the cup simultaneously through an interface plate. The improved flow path is drawn at the vacuum source, through a tube, to the sliding translation mechanism, and then is either provided at the cup or is split into the bellows and the cup.

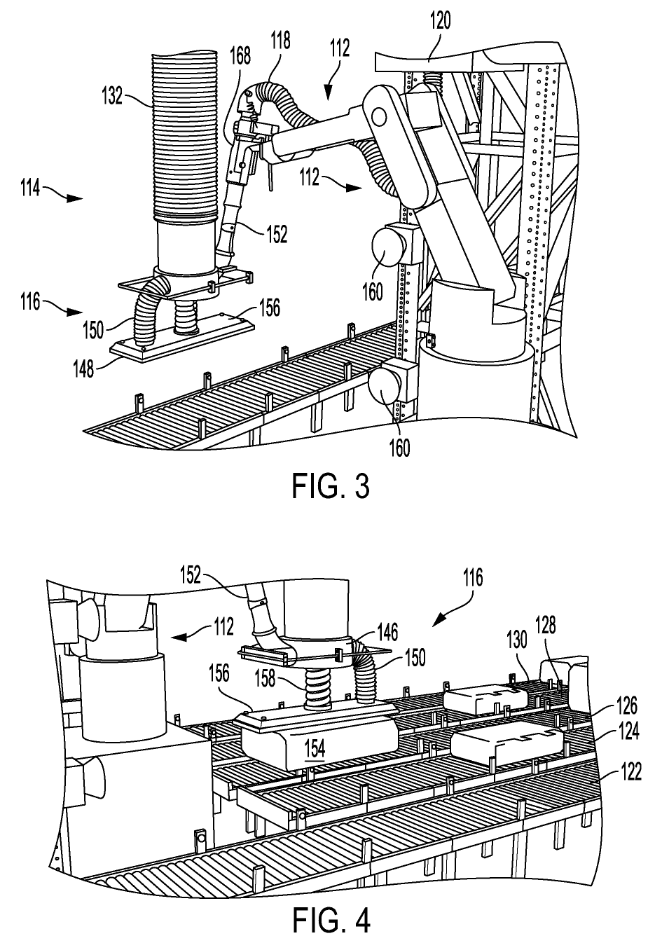

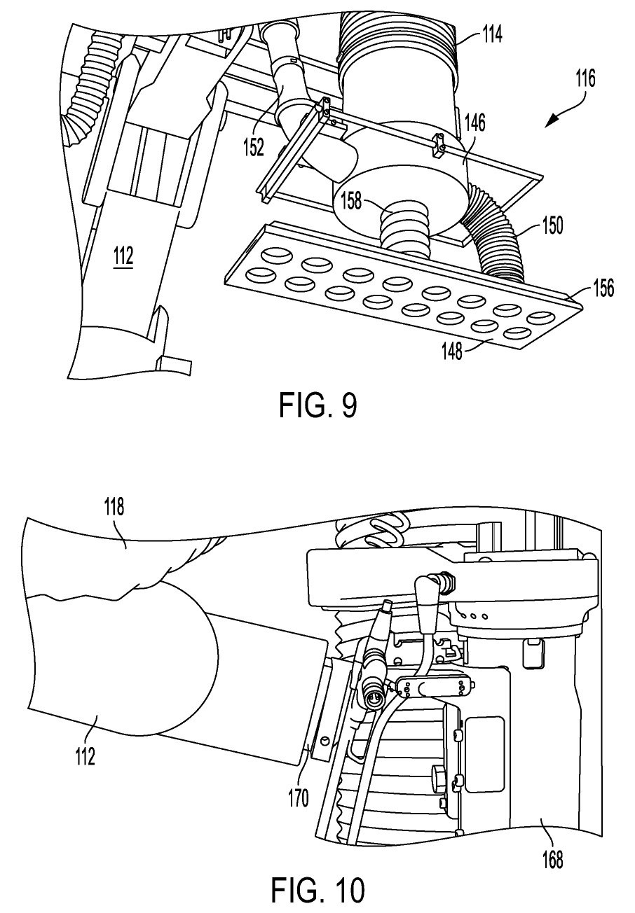

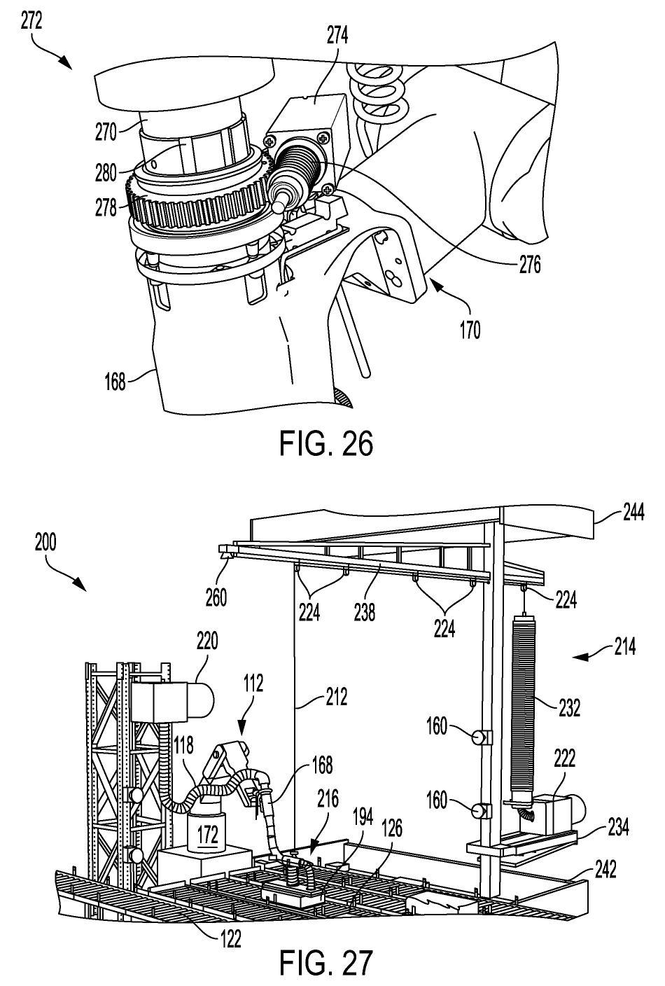

FIG. 3 shows an enlarged view of the programmable motion device 112 with the vacuum lift assist end-effector system 116, which includes a vacuum flow valve control system 146 (further shown in FIGS. 11A and 11B), a vacuum applicator surface 148 (further shown in FIG. 9), and an end-effector vacuum hose 150. Vacuum flow is drawn through the vacuum flow control valve 146 via an end-effector coupling 152 that is coupled to the vacuum hose 118. The end-effector coupling is rotatable within an end-effector mount 168 (as discussed further below with reference to FIG. 26), and the end-effector mount 168 is attached to the programmable motion device. FIG. 4 shows an enlarged view of the vacuum lift assist end-effector system 116 with an object 154 being grasped by the vacuum lift assist end-effector system 116. The vacuum applicator surface 148 is provided on the underside of a vacuum applicator 156 that is attached to the vacuum flow control valve 146 via a compression spring 158 (to absorb impact when grasping or placing objects).

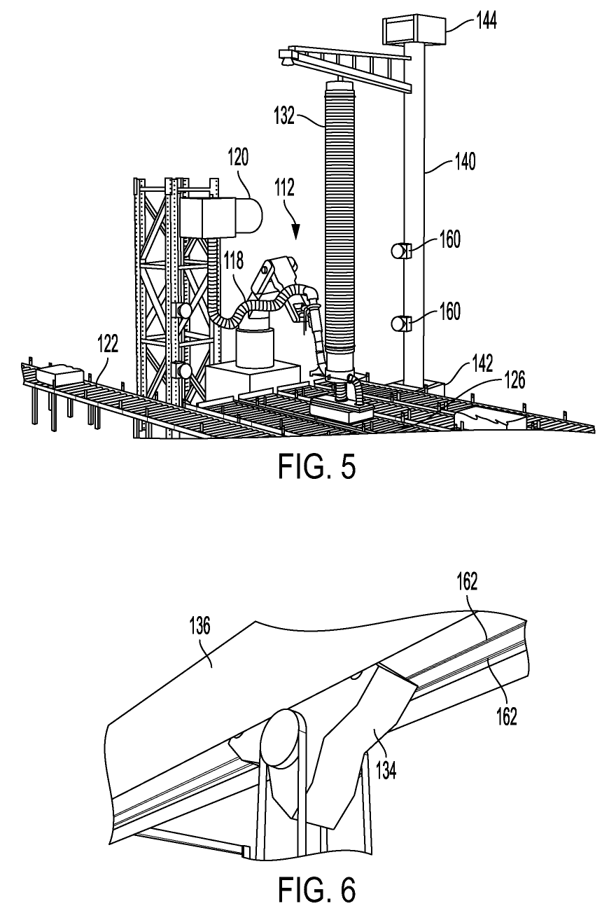

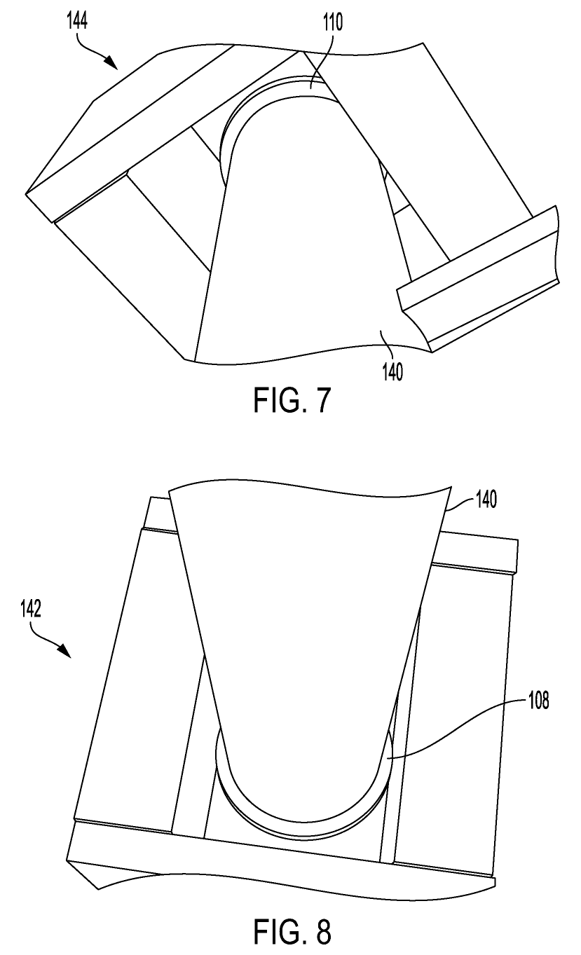

Perception units 160 are provided throughout the work environment for assisting the programmable motion device 112 in interfacing with the objects on the in-feed conveyor 122 and the output conveyors 124 - 130. The programmable motion device 112 is free to move within the work environment, and as noted above, the bellows 132 moves with the vacuum lift assist end-effector system 116. FIG. 5 shows the programmable motion device 112 having moved the end-effector 116 to a placement location on output conveyor 126. Note that as compared to the view in FIG. 1, the trolley 134 has moved along the boom 136, and the tower 140 has rotated about the lower tower support 142 and upper tower support 144. FIG. 6 shows the trolley 134 that travels along tracks 162 within boom 136 (on both inner sides). FIG. 7 shows the upper end of the tower 140 that is supported by upper tower support 144 with an upper bearing 110 to permit rotation, and FIG. 8 shows the lower end of the tower 140 that is supported by lower tower support 142 with a lower bearing 108 to permit rotation of the tower. One skilled in the art will appreciate that the upper support of the vacuum lifting system can be suspended from trusses within the facility, or from a crane gantry supported only from the base without departing from the scope and spirit of the invention. Again, in accordance with certain aspects of the invention, the position of the trolley 134, serving as the anchor, and positioned above the vacuum lift assist end-effector system 116 may be powered (e.g., by motors rotating the tower 140 and driving the trolley 134 over the boom 136) to move the vacuum lifting system 114, and specifically, the bellows 132, responsive to the known movement of the vacuum lift assist end-effector system 116 such that the bellows 132 is always anchored from above, and vertically aligned with, the vacuum lift assist end-effector system 116.

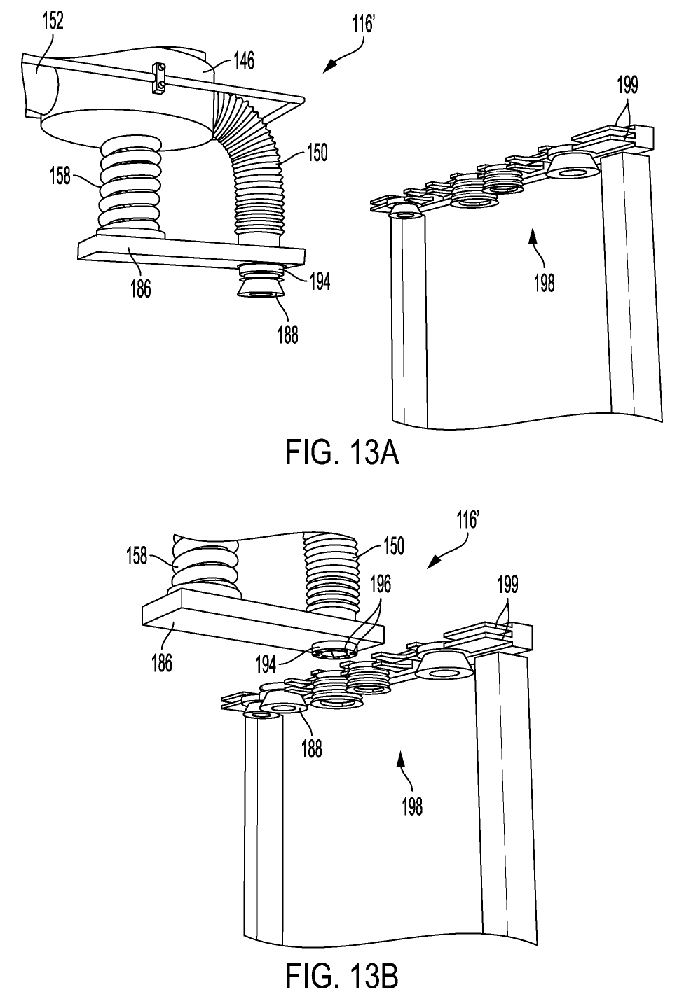

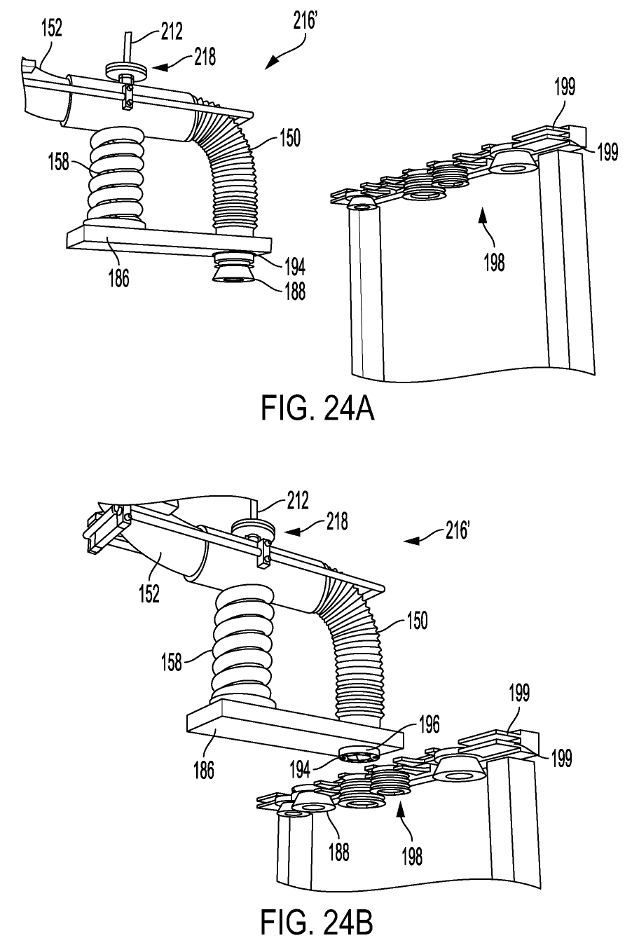

FIG. 9 shows an underside view of the vacuum lift assist end-effector system 116 showing vacuum apertures in the vacuum applicator surface 148 of the vacuum applicator 156. The interior of the vacuum applicator 156 is open to both the distal end of the end-effector vacuum hose 150 and the apertures in the vacuum applicator surface 148, providing vacuum force across the applicator surface 148. The vacuum applicator 156 is suspended from the vacuum flow control valve 146 by a stiff spring 158 that accommodates some deflection of the end-effector system 116 in grasping and placing objects. The end-effector vacuum hose 150 is flexible and accommodates any movement of the vacuum applicator 156 with respect to the vacuum flow control valve 146. As discussed in more detail below (and in particular with reference to FIGS. 13A, 13B, 24A, 24B), the vacuum applicator surface may instead include a vacuum cup in communication with the distal end of the end-effector vacuum hose 150 in accordance with further aspects of the present invention.

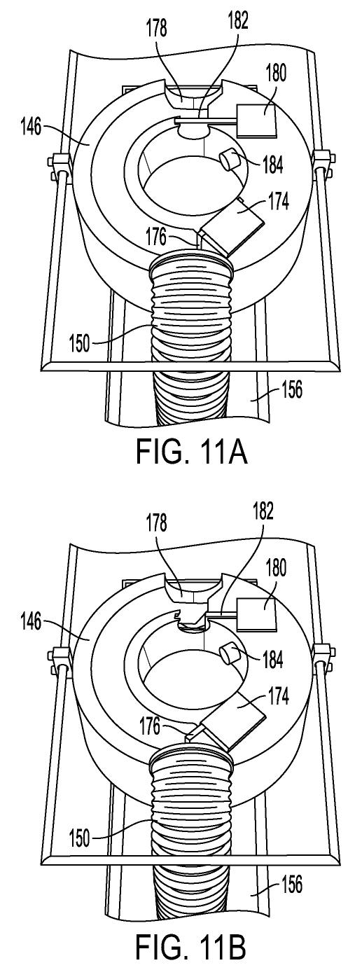

As noted above, the end-effector coupling 152 is rotatable within the end-effector mount 168 and the end-effector mount 168 is attached to the programmable motion device via a force torque sensor 170 as shown in FIG. 10. Information from the force torque sensor 170 is communicated to the one or more computer processing systems 1000 (shown in FIG. 1) that provide the functionality for the operation of the object processing systems disclosed herein. The programmable motion device may further include its own control processing system in its base 172 thereof (also shown in FIG. 1).

The vacuum flow control valve 146 may include a single valve that selectively adjusts the vacuum flow between the vacuum applicator surface and the lifting bellows 132. FIGS. 11A and 11B show an illustrative diagrammatic view of the inside of the vacuum flow control valve 146 in accordance with an aspect of the present invention that includes two valves for illustrative purposes. In particular, and with reference to FIG. 11A, vacuum flow from the vacuum applicator 156 is drawn up through the end-effector vacuum hose 150 through the open valve 174 (including valve gate 176), along the curved inner channel and up through the opening 178 to the end-effector coupling 152, which is connected to the vacuum source 120 via vacuum hose 118. A valve 180 (including valve gate 182) remains closed and the end-effector system 116 operates to process objects not requiring lift assistance.

With further reference to FIG. 11B, when lift assistance is needed, the valve 180 opens the gate 182 to cause vacuum to flow from the lifting bellows 132 up through the end-effector coupling 152 (not shown in FIG. 11B for clarity) at the opening 178. The gate 176 of the valve 174 may partially close to balance the amount of vacuum used for both evacuating the lifting bellows and for providing vacuum at the vacuum applicator surface. The valves 174, 180 are so activated when lifting assist is needed (and optionally to the extent that lifting assistance is needed) from the lifting bellows 132. In other words, the gates may be opened a sufficient amount that the vertical lifting force applied by the programmable motion device 112 as detected by the force torque sensor 170 falls below a threshold. Vacuum pressure and/or vacuum flow may also be monitored by pressure/flow sensor 184 (shown in FIGS. 11A and 11B), and pressure/flow sensors in the high flow vacuum source 120 (not shown).

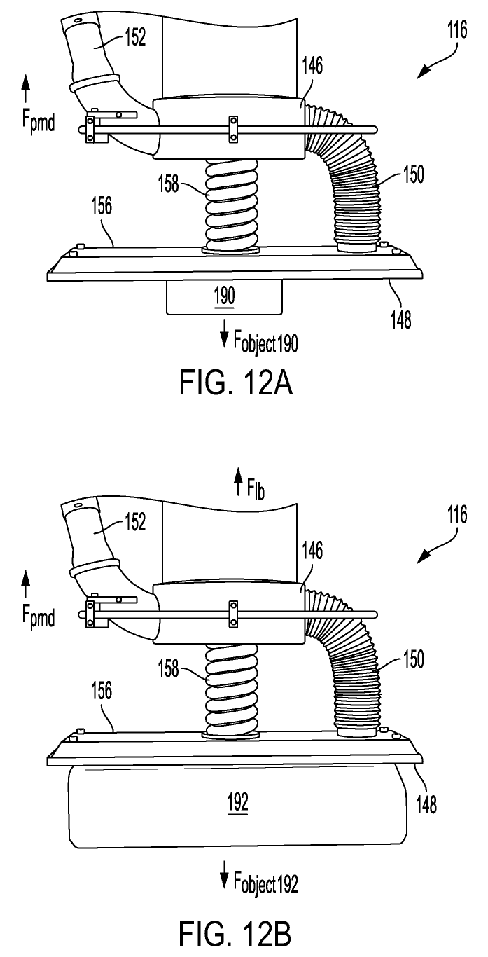

FIG. 12A shows an illustrative diagrammatic view of the end-effector system 116 grasping a relatively light weight object 190 such that the force of the weight of the object (as shown at F_{object 190}) may be countered by the lifting force of the programmable motion device (shown at F_{pmd}) without exceeding a maximum threshold. FIG. 12B shows an illustrative diagrammatic view of the end-effector system 116 grasping a relatively heavy object 192 such that the force of the weight of the object (as shown at F_{object 192}) exceeds a maximum threshold of the programmable motion device. In this case the lifting bellows is engaged (e.g., through valve 180) to apply additional lifting force (F_{l.b.}) by the lifting bellows 132. The lifting force may therefore be dynamically engaged either before or during the lifting process, e.g., responsive to a known weight of the object or responsive to a detected threshold weight of the object (e.g., via force torque sensor 170).

An advantage of this design is that it allows the cup and lifting mechanism to be detached from the high flow suction gripper. When the applicator is detached, the bellows and cup are both depressurized and detached from the system. This allows the programmable motion device 112 to return to being a high flow suction gripper without any lift assist. When attached, the bellows is fluidically connected to the high flow suction line and lift assist is provided on the vacuum lift assist end-effector system 116. The bellows is also anchored to the boom allowing for its contraction under the vacuum to lead to the lift of the device. And the use of a translating decoupled high flow suction gripper allows for the z position of the cup to be decoupled from the z position of the end-effector of the programmable motion device 12. Each applicator however, needs to be attached to a bellows (with the bellows attached to the boom). Each applicator therefore must have a bellows associated with it which makes applicators swapping between multiple vacuum assisted applicators more difficult in requiring a secondary applicator interface.

In accordance with further aspects of the invention, a vacuum lift assist end-effector system 116’ may be provided that includes the vacuum flow valve control system 146 coupled to the end-effector coupling 152, the end-effector vacuum hose 150 and the mounting spring 158 discussed above as shown in FIGS. 13A and 13B. The end-effector system 116’ however includes a vacuum applicator 186 that includes a mounting ring 194 with magnets 196 for attachment to any of a variety of vacuum cups (e.g., 188 and as shown generally at 198). FIG. 13A shows the vacuum cup 188 attached to the mounting ring 194 of the vacuum applicator 186, and when so mounted the vacuum flow runs up through the cup 188, through an aperture in the applicator 186 and through the end-effector vacuum hose 150 (and onward as discussed above). With reference to FIG. 13B, when the vacuum cup 188 is horizontally moved between rack portions 199 and the end-effector system 116’ is then lifted, the vacuum cup 188 remains on the rack. When a new vacuum cup is to be mounted on the end-effector system 116’, the end-effector system 116’ is engaged to position the mounting ring 194 over the selected vacuum cup so that the vacuum cup’s upper ring (formed of metal) engages the magnets 196 of the mounting ring 194. The end-effector 116’ then moves the mounting ring 194 (with the attached new cup horizontally to remove the newly attached vacuum cup). The object processing systems 100, 100’ therefore provides that selective vacuum lifting assistance may be selectively available together with a system that permits exchanging vacuum cups in a vacuum cup exchange system in the work environment.

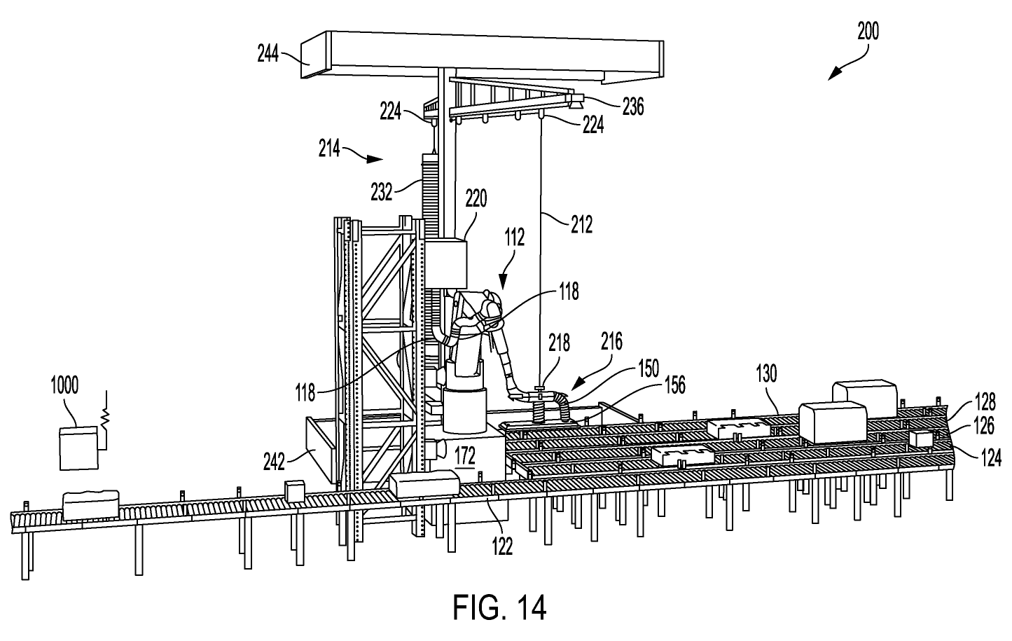

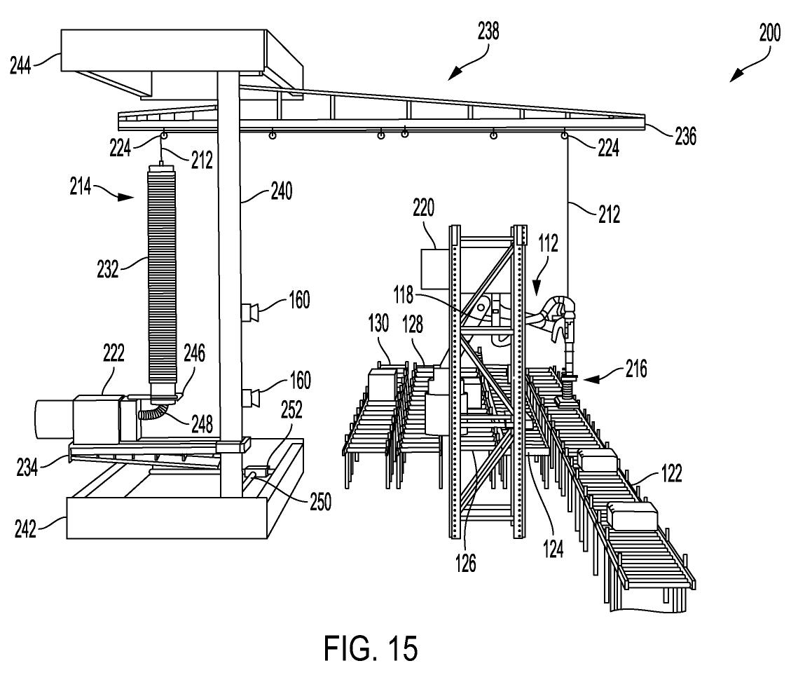

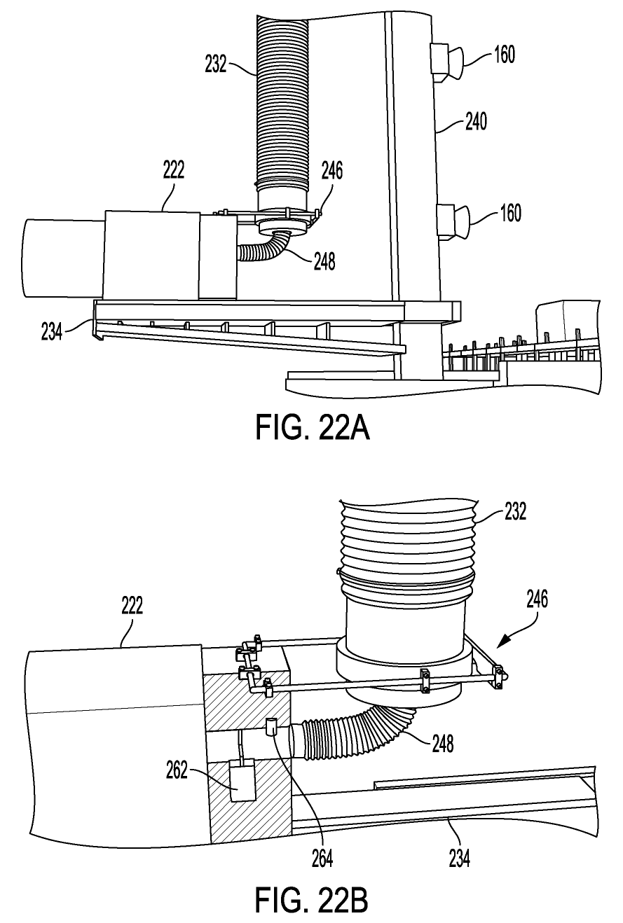

With reference to FIG. 14, an object processing system 200 in accordance with an aspect of the present invention includes a programmable motion device 112 and a vacuum lifting system 214. The programmable motion device 112 and the vacuum lifting system 214 are selectively attached by virtue of a cable attachment 218, and when attached, the programmable motion device 112 receives lift assistance from the vacuum lifting system 214 through a cable 212. The programmable motion device 112 uses a first high vacuum source 220 routed through vacuum hose 118 to a vacuum lift assist end-effector system 216 where the vacuum passes directly through to a vacuum applicator 156 through vacuum hose 150. The first high flow vacuum source 220 may, for example, provide at the vacuum lift assist end-effector system 216 an air flow of at least about 100 cubic feet per minute, and a vacuum pressure of no more than about 100,000 Pascals below atmospheric, or no more than about 85,000 Pascals below atmospheric, or no more than about 65,000 Pascals below atmospheric. Objects to be processed are provided to the programmable motion device 112 on an in-feed conveyor 122, and are provided to any of first output conveyor 124, second output conveyor 126, third output conveyor 128 or fourth output conveyor 130 by the programmable motion device 112. One skilled in the art would appreciate that the object processing performed by the programmable motion device 112 represented by moving an object from the input conveyor 122 to any one of the output conveyors can be applied to any number of object processing tasks of a programmable motion device within the scope and spirit of the claimed invention. Object processing tasks can include palletizing objects and materials, sorting of objects, order fulfillment, and decanting of objects or materials, without limitation. With continued reference to FIG. 14 and with reference to FIG. 15, the vacuum lifting system 214 includes an elongated bellows 232 extending from a vacuum lifting system base 234 that is connected to the lifting cable 212 that travels through pulleys 224 along a beam 236 to form an anchor that is held above the programmable motion device 112 by a tower 240. The tower 240 is supported by a lower stage 242 and an upper stage 244, both of which include a movable x-y stage of slide rails 250 and corresponding linear bearings (described in further detail below). The vacuum lifting system 214 tracks the x and y component of motion of the vacuum lift assist end-effector system 216 as the programmable motion device 112 moves within the work environment with the z component of motion tracked by the expansion and contraction of the elongated bellows 232 tied to the lifting cable 212 when the lifting cable 212 is attached to the vacuum lift assist end-effector system 216 at the cable attachment 218. In accordance with further aspects of the invention, the upper stage 244 and the lower stage 244 may be actively driven in concert with the movements of the programmable motion device 112 to provide that the lifting cable 212, anchored at the cable attachment 218, remains aligned with the vacuum lift assist end-effector system 216 while the programmable motion device 112 moves within the work environment. When the lifting cable 212 is attached to the vacuum lift assist end-effector system 216 at the cable attachment 218, the vacuum lifting system 214 can provide lifting assistance when vacuum is applied to the elongated bellows 232 from the second high flow vacuum source 222. By modulating the flow of vacuum by the second high flow vacuum source 222 and/or controlling the flow of vacuum to the elongated bellows 232 using a vacuum flow control valve (described in further detail below with reference to FIG. 22B), the amount of lift assistance supplied by the vacuum lifting system 214 to the vacuum lift assist end-effector system 216 can be controlled.

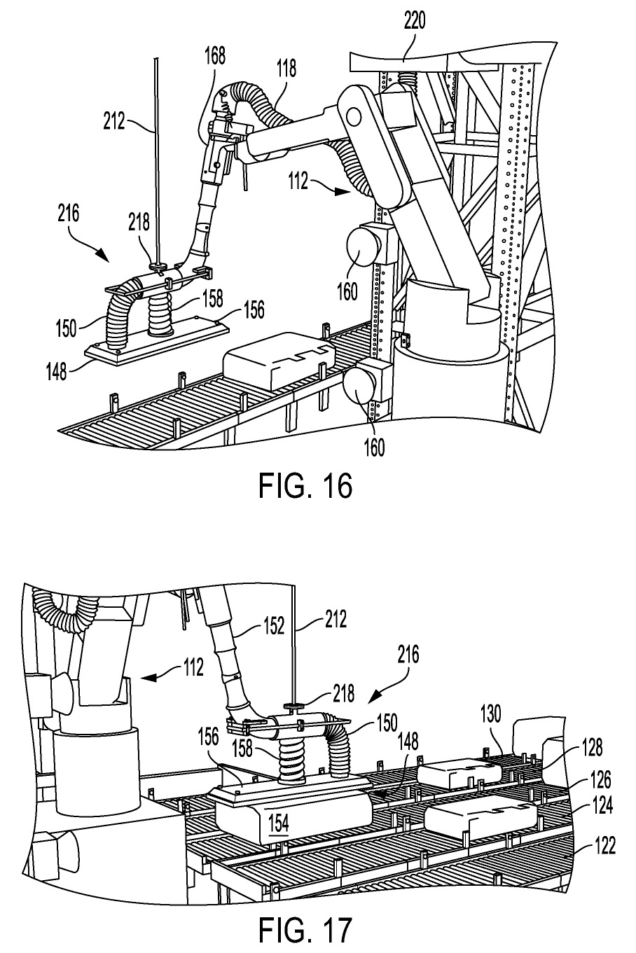

FIG. 16 shows an enlarged view of the programmable motion device 112 with the vacuum lift assist end-effector system 216, which includes the lifting cable 212 attached to the vacuum lift assist end-effector system 216 using cable attachment 218. The vacuum lift assist end-effector system 216 includes a vacuum applicator surface 148 (as previously described with reference to FIG. 9), and an end-effector vacuum hose 150, and coupled to vacuum hose 118. The end-effector coupling is rotatable within an end-effector mount 168 (as discussed further below with reference to FIG. 26), and the end-effector mount 168 is attached to the programmable motion device 112. FIG. 17 shows an enlarged view of the vacuum lift assist end-effector system 216 with an object 154 being grasped by the vacuum lift assist end-effector system 216. The vacuum applicator surface 148 is provided on the underside of the vacuum applicator 156 that is attached to the vacuum lift assist end-effector system 216 and the programmable motion device 112 via a compression spring 158 (to absorb impact when grasping or placing objects).

Perception units 160 are provided throughout the work environment for assisting the programmable motion device 112 in interfacing with the objects on the in-feed conveyor 122 and the output conveyors 124 - 130. The programmable motion device 112 is free to move within the work environment, and the lifting cable 212, as a component of the vacuum lifting system 214 with the bellows 232 attached to the vacuum lifting system base moves with the vacuum lift assist end-effector system 216.

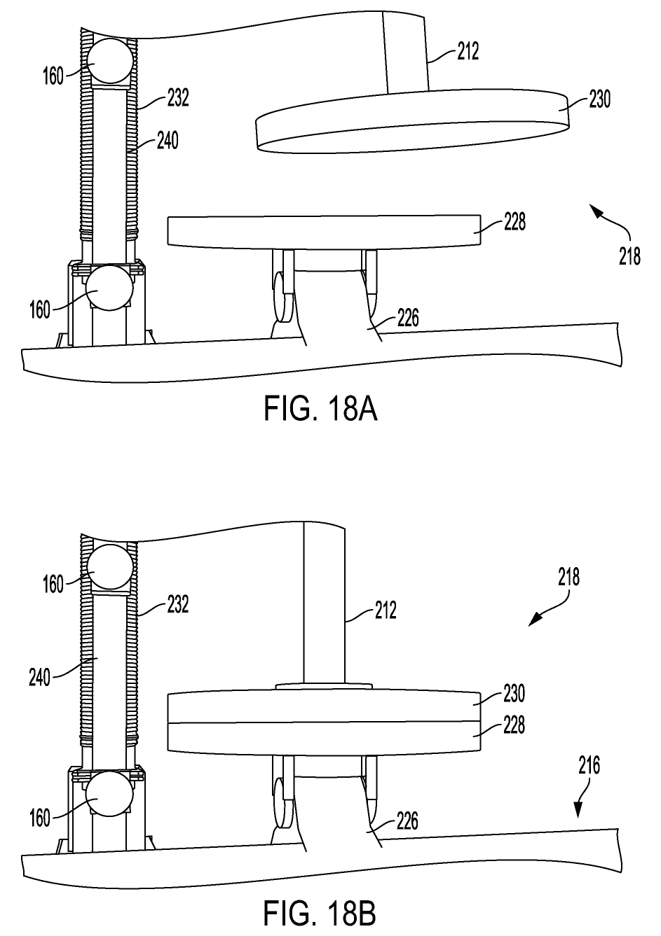

Optionally, the vacuum lifting system 214 can be temporarily disconnected from the programmable motion device 112 where the cable attachment 218 can be detached. In the detached mode, the object processing system 200 can be operated without lift assistance. When operating the object processing system 200 without lift assistance, the programmable motion device 112 operates conventionally, using high flow vacuum from the first high flow vacuum source 220 to grasp objects from the in-feed conveyor 122 to be deposited on any one of the output conveyors 124 - 130. When a heavy object requires processing by the programmable motion device 112, the lifting cable 212 is re-attached at the cable attachment 218. The attachment and detachment of the lifting cable 212 at the cable attachment can be performed manually by an operator, or it can be automatically performed without human assistance. Referring to FIG. 18A and 18B, a magnetic attachment mechanism is provided as the cable attachment 218. A lifting cable attachment magnet 230, fabricated of a ferrous or otherwise magnetic material is attached to the lifting cable 212 and an end-effector attachment magnet 228 is attached to the end-effector of the vacuum lift assist end-effector system 216 at lift assist mounting point 226. The end-effector attachment magnet 228 can be provided as an electromagnet with control wires (not shown) attached at the lift assist mounting point and passing through the end-effector and through the programmable motion device 112. When detached, the vacuum lifting system 214 can apply modest vacuum pressure to the elongated bellows 232 to contract the elongated bellows 232 sufficient to raise the lifting cable attachment magnet 230 attached to the lifting cable 212 so as to not interfere with the operation of the programmable motion device 112 when performing tasks without lifting assistance. When a heavy object requires movement by the programmable motion device 112 with lift assistance, the programmable motion device 112, with perception data supplied by the perception units 160 locates and moves the end-effector attachment magnet 228 to be in close proximity to the lifting cable attachment magnet 230, in cooperation with the vacuum lifting system 214 to vent the vacuum pressure from within the elongated bellows 232 so that the lifting cable attachment magnet 230 is lowered within reach of the end-effector attachment magnet 228. The end-effector attachment magnet 228 is activated to attach the lifting cable to the vacuum lift assist end-effector system 216.

In accordance with certain aspects, the object processing system may provide a breakaway link between the vacuum lifting system and the end-effector system, and in particular with reference to FIGS. 14, 17, 18A and 18B the magnets 228 and 230 of the cable attachment 218 may be designed to break apart at threshold separation force, protecting the system from both too strong a lifting force and too heavy a load. Either of the magnets 228, 230 may also be provided as an electromagnet and either may be simply a ferromagnetic metal that is engaged by the other being provided as a magnet. Each of the embodiments of the invention as disclosed and taught herein may include such a breakaway link.

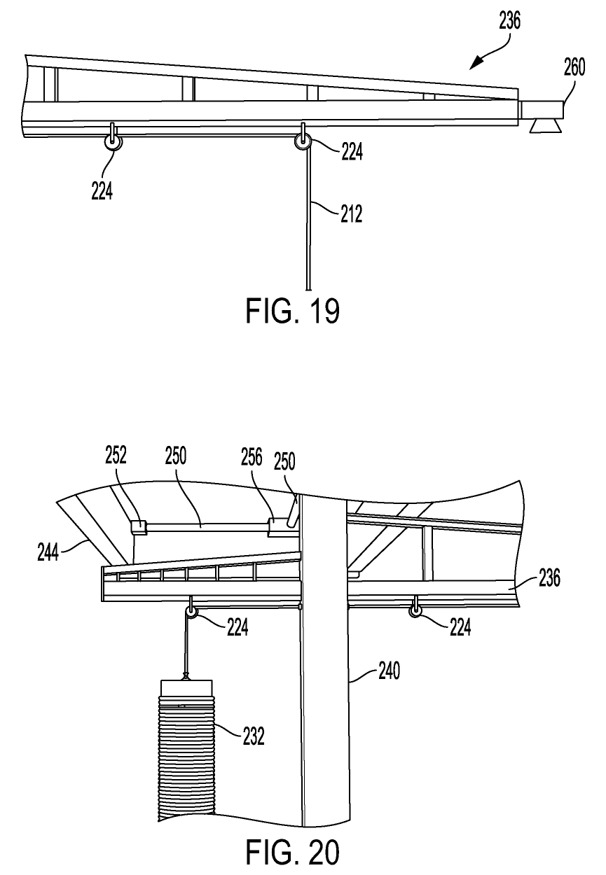

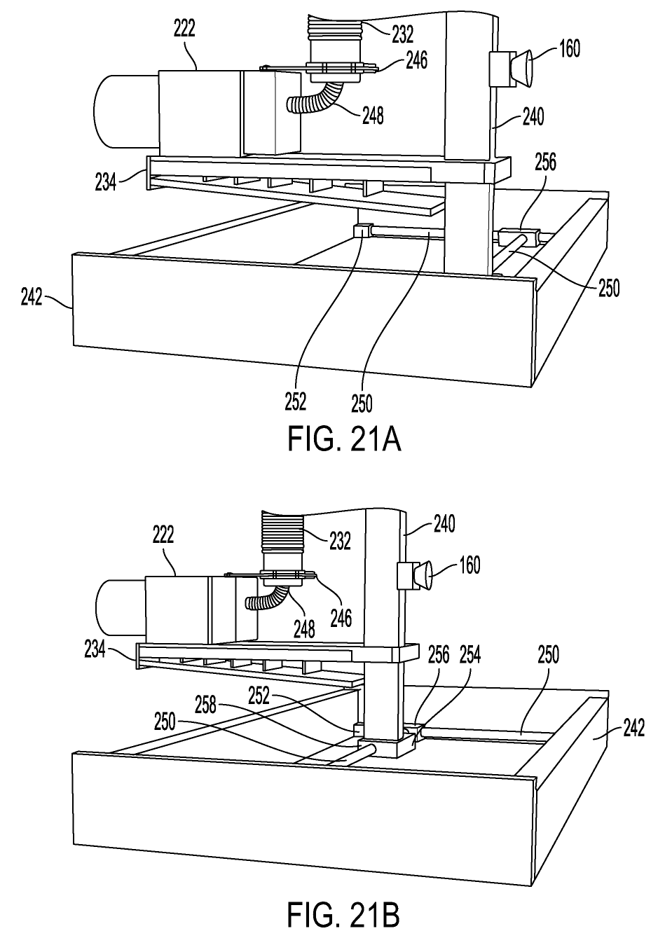

With reference to FIGS. 19, 20, 21A, and 21B, the operation of the vacuum lifting system 214 can be described when the lifting cable 212 is attached to the vacuum lift assist end-effector system 216. FIG. 19 shows the beam 236 with the lifting cable 212 suspended by pulleys 224 to vertically anchor the lifting assistance. The lifting cable 212 can be a synthetic strand or braded rope, or a metallic cable of sufficient tensile strength to withstand the anticipated lifting forces required with sufficient durability to withstand cyclical loading and abrasion resistance. The pulleys 224 are necessary to eliminate drag resistance so that the lifting forces can be applied by contraction of the elongated bellows without resistance from transmission of the lifting forces through the lifting cable 212. Perception unit 260 can provide additional perception data relating to the attachment and detachment of the lifting cable 212 as previously described as well as locating the actual position of the lifting cable attachment magnet when the lifting cable 212 is detached from the vacuum lift assist end-effector system 216. FIG. 20 depicts an enlarged view of the portion of the beam 236 that is attached to the tower 240 with the lifting cable attached to the end of the elongated bellows 232. The representation of the vacuum lifting system 214 according to FIG. 20 shows the upper stage 244 with the slide rails 250 that permit the vacuum lifting system 214 to move in the X,Y coordinates that correspond to the X,Y components of the motion of the vacuum lift assist end-effector system 216 as moved by the programmable motion device 112. FIG. 21A depicts an enlarged view of the position of the vacuum lifting system 214 in one extreme position with FIG. 21B depicting an enlarged view of the position of the vacuum lifting system 214 in another extreme position. As shown in FIG. 21B, the tower 240 is set on a slide bearing 258 that moves in the y direction over the slide rail 250.

The lower stage 242 and the upper stage 244 can be passively moved where movement of the programmable motion device 112, or specifically, movement of the cable attachment 218 on the vacuum lift assist end-effector system 216 is followed by the vacuum lifting system 214 as the slide bearings 256 of the upper stage 244 and the slide bearings 256 of the lower stage 242 slide freely on the slide rails 250. Alternatively, the position of the vacuum lifting system 214 can be actively driven by a linear motor y stage 252 and linear motor x stage 254 where the slide rails 256 are provided as threaded rods and the slide bearing 256 and slide bearing 258 are provided as linear bearings engaged in the threaded slide rails 256. When actively driven, the upper stage 244 and lower stage 242 maintain the position of the tower 240, and thus, the beam 236, and correspondingly, the cable attachment 218 aligned with the pulley 224 at the end of the beam 236 so that the lifting cable 212 is vertically aligned as the programmable motion device 112 moves about the workspace.

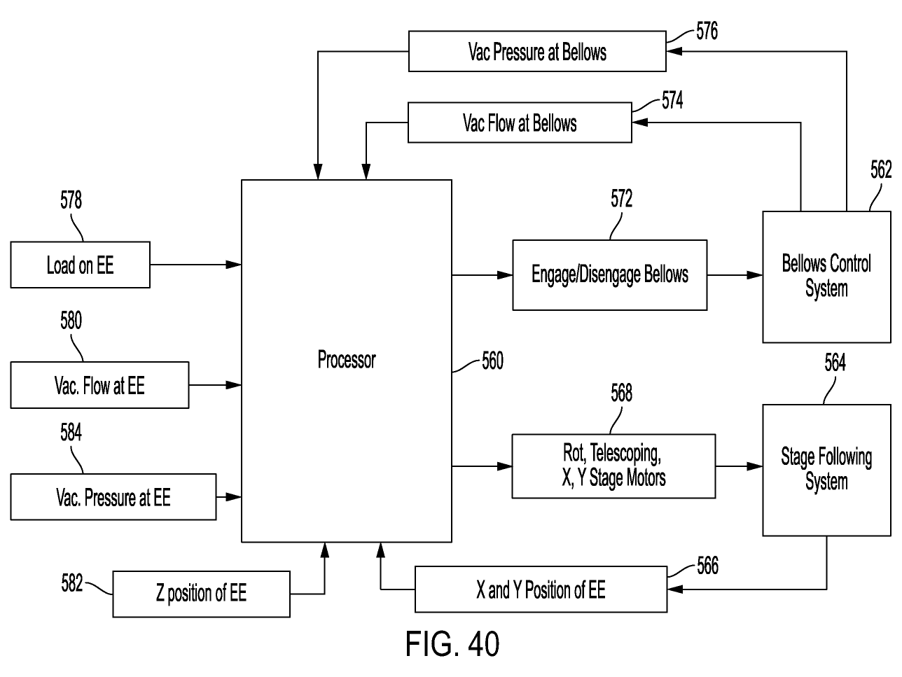

With reference to FIG. 22A, the vacuum lifting system base 234 is shown attached to the lower end of the tower 240. When the vacuum lifting system 214 is providing lifting assistance to the programmable motion device 112, the lifting force pulling up on the cable attachment 218 on the vacuum lift assist end-effector system 216 is supplied by a contraction of the elongated bellows 232. The bottom end of the elongated bellows 232 is attached to the vacuum lifting system base by virtue of a bracket 246 (shown in FIG. 22A as attached to the second high flow vacuum source 222 for clarity). FIG. 22B shows the base of the elongated bellows 232 attached to the vacuum lifting system base 234 with bracket 246, with a portion of the second high flow vacuum source 222 in partial cutaway view. The vacuum hose 248 that supplies vacuum to the elongated bellows 232 is attached to the second vacuum source 222 with a vacuum flow valve 262 and a pressure sensor 264. The amount of vacuum (in terms of flow and/or absolute pressure) supplied to the elongated bellows must be controlled to modulate the amount of lift supplied to the lifting cable 212. The control of the vacuum flow valve 262 and the regulation of the second high flow vacuum source 222 in response to the output of the pressure sensor 264 (as will be discussed further below with reference to FIG. 40) is necessary to match the vertical force component on the programmable motion device 112 to at least a portion of the mass of the object being moved by the vacuum lift assist end-effector system 216. The control of the vacuum flow valve 262 and the regulation of the second high flow vacuum source 222 in response to the output of the pressure sensor 264 is also necessary to raise and lower the lifting cable attachment magnet 230 while the vacuum lifting system 214 is detached from, or being re-attached to, the vacuum lift assist end-effector system 216 when the programmable motion device 112 is operating in the detached mode.

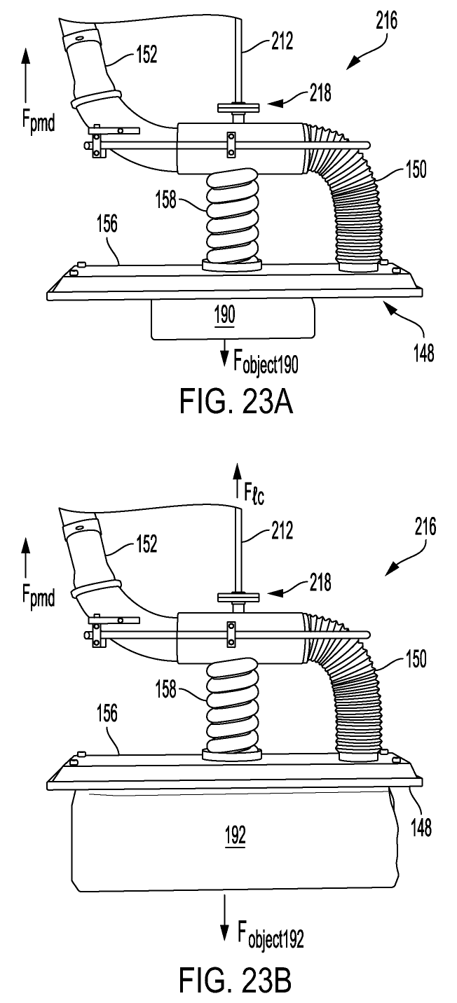

FIG. 23A shows an illustrative diagrammatic view of the vacuum lift end-effector system 216 grasping a relatively light weight object 190 such that the force of the weight of the object (as shown at F_{object 190}) may be countered by the lifting force of the programmable motion device 112 at the end-effector coupling 152 (shown at F_{pmd}) without exceeding a maximum threshold. Object 190 is held to the vacuum applicator surface 148 by high flow vacuum supplied to the vacuum applicator 156 supplied from the end-effector coupling 152 and vacuum hose 150. No lifting assistance is necessary with the vacuum lifting system 214 deactivated (or floating) so no lifting force or resistance from the lifting cable 212 is noted. FIG. 23B shows an illustrative diagrammatic view of the end-effector system 216 grasping a relatively heavy object 192 such that the force of the weight of the object (as shown at F_{object 192}) exceeds a maximum threshold of the programmable motion device 112. In this case the vacuum lifting system 214 is engaged (e.g., through the supply of vacuum to the elongated bellows 232 from the second high flow vacuum source 222) to apply additional lifting force (F_{lc}) by the lifting cable 212. The lifting force may therefore be dynamically engaged either before or during the lifting process, e.g., responsive to a known weight of the object or responsive to a detected threshold weight of the object (e.g., via force torque sensor 170.

An advantage of the object processing system 200 is that it allows the high flow vacuum suction gripper and vacuum lifting system 214 to be either de-activated or detached from the programmable motion device 112. When the vacuum lifting system 214 is de-activated, the bellows is vented to atmosphere to provide no lift assistance or resistance to movement. This allows the programmable motion device 112 to return to being a high flow suction gripper without any lift assist. When the vacuum lifting system 214 is detached the programmable motion device 112 performs as a high flow suction gripper without any lift assist. When attached and activated, the bellows is evacuated by the second high flow vacuum source 222 to provide lift assist through lifting cable 212 to the vacuum lift assist end-effector system 216. When evacuated, the bellows 232 contracts under the vacuum to lead to the lift of the vacuum lift assist end-effector system 216. And the use of a translating decoupled high flow suction gripper allows for the z position of the cup to be decoupled from the z position of the end-effector of the programmable motion device 12. Each applicator however, needs to be attached to a bellow (with the bellows attached to the boom). Each applicator therefore must have a bellows associated with it which makes applicators swapping between multiple vacuum assisted applicators more difficult in requiring a secondary applicator interface.

In accordance with further aspects of the invention, a vacuum lift assist end-effector system 216’ may be provided that includes the end-effector coupling 152, the end-effector vacuum hose 150 and the mounting spring 158 discussed above as shown in FIGS. 24A and 24B. The end-effector system 216’ however includes a vacuum applicator 186 that includes a mounting ring 194 with magnets 196 for attachment to any of a variety of vacuum cups (e.g., 188 and as shown generally at 198). FIG. 24A shows the vacuum cup 188 attached to the mounting ring 194 of the vacuum applicator 186, and when so mounted the vacuum flow runs up through the cup 188, through an aperture in the applicator 186 and through the end-effector vacuum hose 150 (and onward as discussed above). With reference to FIG. 24B, when the vacuum cup 188 is horizontally moved between rack portions 199 and the end-effector system 216’ is then lifted, the vacuum cup 188 remains on the rack. When a new vacuum cup is to be mounted on the vacuum lift assist end-effector system 116’, the vacuum lift assist end-effector system 216’ is engaged to position the mounting ring 194 over the selected vacuum cup so that the upper ring of the vacuum cup (formed of ferrous metal or otherwise magnetic material) engages the magnets 196 of the mounting ring 194. The vacuum lift assist end-effector 216’ then moves the mounting ring 194 (with the attached new cup horizontally to remove the newly attached vacuum cup). The object processing system 200 therefore provides that selective vacuum lifting assistance may be selectively available together with a system that permits exchanging vacuum cups in a vacuum cup exchange system in the work environment.

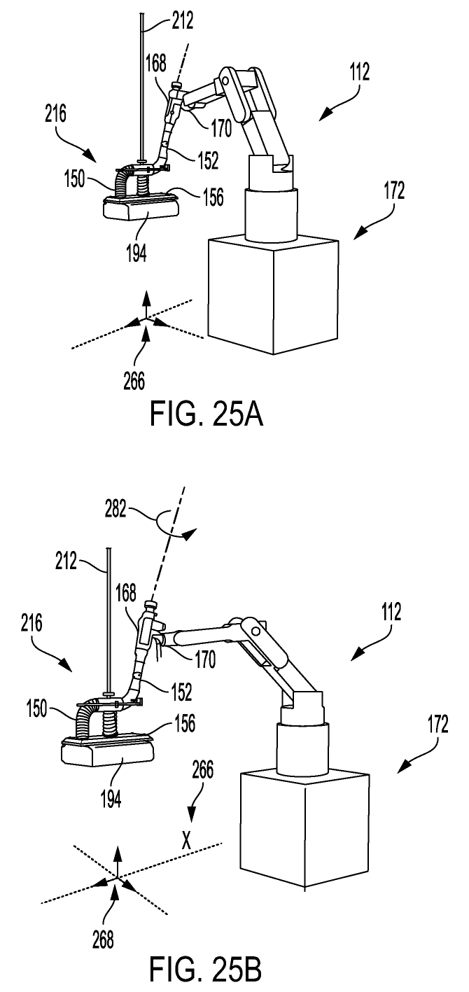

With reference to FIGS. 25A and 25B, the operation and movement of the programmable motion device 112 in conjunction with the vacuum lifting system 214 is described.

As shown in FIG. 25A, the programmable motion device 112 has grasped object 194, which exceeds the maximum threshold of lifting capacity of the programmable motion device 112, thus requiring lift assistance of the vacuum lifting system 214 through a lifting force transmitted through lifting cable 212 as described above. The first high flow vacuum source 220 (not shown for clarity) provides vacuum to the vacuum applicator 156 through vacuum hose 150 and end-effector coupling 152 to grasp the object 194 with high flow vacuum. Lifting cable 212 provides lifting assistance so that the maximum threshold of lifting capacity of the programmable motion device 112 is not exceeded, as measured, and thus controlled, by force torque sensor 170. The X,Y position of the vacuum lift assist end-effector system 216 is shown as the first position 266, projected on the plane corresponding to the bottom of the base 172 of the programmable motion device 112 As shown in FIG. 25B, the programmable motion device 112 is articulated to extend its reach so that the vacuum lift assist end-effector system 216 is moved to a different position in three-dimensional space with the X,Y position of the vacuum lift assist end-effector system 216 shown as the second position 268, projected on the plane corresponding to the bottom of the base 172 of the programmable motion device 112. The motion of the various elements of the programmable motion device 112 includes rotation of various joints including a yaw motion 282. In order for the lifting force transmitted through lifting cable 212 to be maintained, the position of the lifting cable in the X,Y dimension is followed by the vacuum lifting system 214 (as described above), with the lifting force modulated by the second high flow vacuum source 222 (as described above) as necessary to not exceed the maximum threshold of lifting capacity of the programmable motion device 112 (which may be a dynamic threshold depending on the amount of articulation of the various elements of the programmable motion device 112).

When processing objects according to the object processing system 200, the movement of the programmable motion device 112 is controlled to maintain the relative orientation of the object 194. FIG. 26 is an enlarged view of the end-effector mount 168 that provides the yaw motion 282 of the programmable motion device 112 to maintain the orientation of the object 194. Manipulating the position and orientation of the vacuum lift assist end-effector system 216 requires movement of different joints (sometimes many of the joints) of the articulated arm elements of the programmable motion device 112. While a rigid object has six degrees of freedom (X, Y, Z, yaw, pitch, roll), each joint of an articulated arm generally has one degree of freedom. Through a combination of changing multiple joints, robotic systems may change the position and orientation of an end-effector. To move an end-effector from one position or even orientation to another, typically involves a more complex set of movements of a plurality of joints rather than simply moving one joint. The complexity of this action is even greater when the vacuum lifting system 214 must follow and/or synchronize the motion with the lifting cable 212 attached to the vacuum lift assist end-effector system 216. Each joint of the programmable motion device 112 typically has a limited range (and single dimension) of movement (such as for example, an elbow joint). In view of this, sometimes during use, a desired position/orientation of an end-effector and a current position/orientation of the end-effector are not connected by any viable path. In other words, all paths in, for example, 6 degrees of freedom are blocked. Also, sometimes a viable path may involve significant movement of a very heavy portion of the articulated arm, slowing throughput with time loss and energy consumption.

As shown in FIG. 26, the end-effector mount 168 includes a rotational shaft portion 270 through which high flow vacuum is supplied to the end-effector coupling 152 (not shown). A rotational system 272 includes a motor 274 driving a worm screw 276. The worm screw 276 engages a spline gear 278 that engage drive splines 280 of the rotational shaft. Yaw adjustment of the vacuum lift assist end-effector system 216 is thus provided by actuation of the motor 274 to rotate the rotational shaft 270 attached to the end-effector coupling 152 to provide a motion of the vacuum lift assist end-effector system 216 in such a way that the vacuum lifting system 214 can follow or synchronize in motion.

FIG. 27 depicts the completion of the processing of the object 194 by object processing system 200 with the use of lift assistance by the vacuum lifting system 214, placing object 194 on output conveyor 126. The vacuum lifting system 214 follows the motion of the vacuum lift assist end-effector system 216 providing lift assistance by transmitting lifting force through lifting cable 212, passing through pulleys 224 that vertically anchor the lift assistance, generated by the evacuation of elongated bellows 232 (and thus, a reduction in the overall length of the elongated bellows 232) through a controlled modulation of the second high flow vacuum source 222.

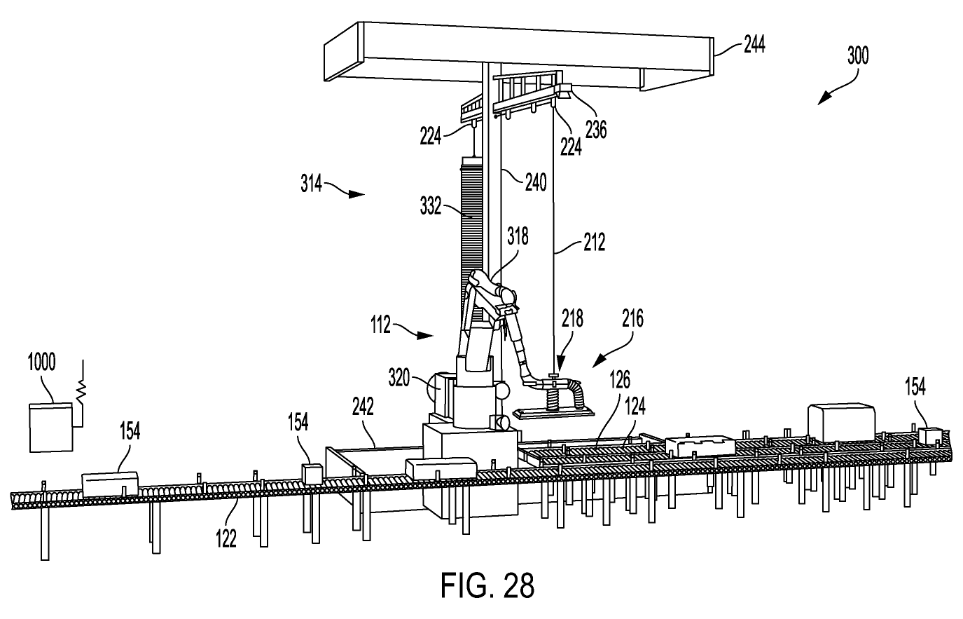

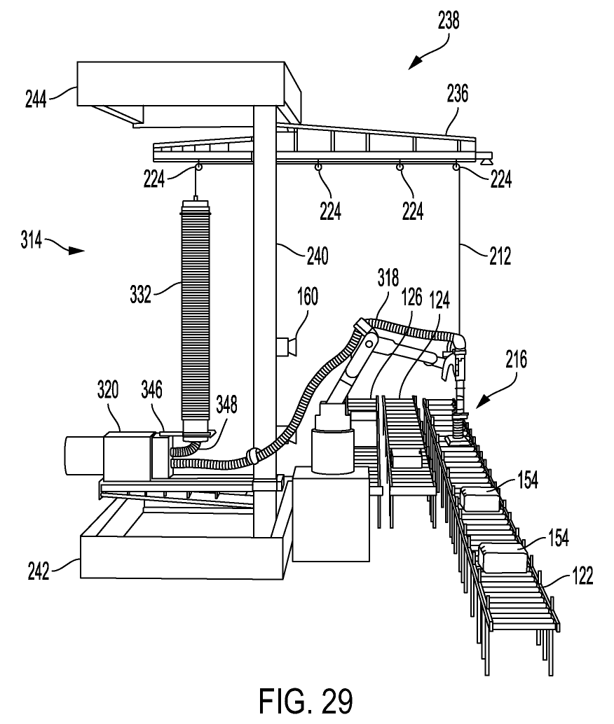

With reference to FIG. 28, an object processing system 300 in accordance with an aspect of the present invention includes a programmable motion device 112 as previously described and a vacuum lifting system 314. The programmable motion device 112 and the vacuum lifting system 314 are selectively attached by virtue of a cable attachment 218, and when attached, the programmable motion device 112 receives lift assistance from the vacuum lifting system 314 through the lifting cable 212, cooperatively vertically anchored by pulleys 224. As shown with respect to FIG. 28, the programmable motion device 112 processes objects 154 by grasping the object 154 on the in-feed conveyor 122 with the vacuum lift assist end-effector system 216 and placing the object 154 on one of the output conveyor 124 and output conveyor 126. As shown in FIG. 29, and with continued reference to FIG. 28, the vacuum lifting system 314 includes a gantry system 238 that supports the lifting cable in pulleys 224 suspended from a beam 236 held by a tower 240 that is positionally controlled through lower gantry stage 242 and upper gantry stage 244 as previously described. The programmable motion device 112 and the vacuum lifting system 314 are integrated together at a high flow vacuum source 320 with a vacuum flow control valve 346 that selectively ports high flow vacuum to an elongated bellows 332 and high flow vacuum to the programmable motion device 112 through vacuum hose 318.

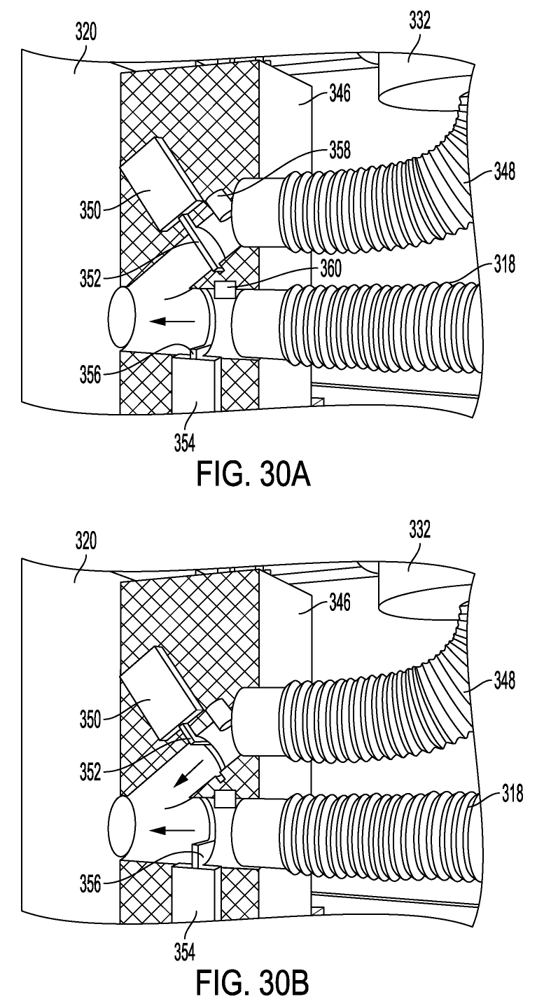

FIGS. 30A and 30B depict an enlarged, diagrammatic side cut-away view of the vacuum flow control valve 346 in two representative modes. FIG. 30A shows the vacuum hose 318 being supplied full high flow vacuum with the grasp control valve 354 fully opening the grasp control gate 356 open, as measured and reported by first pressure sensor 360. Lift assist is disabled with the lift control valve 350 fully closing the lift control gate 352 fully closed. In the representation according to FIG. 30A, effectively no vacuum pressure is ported to vacuum hose 348 and elongated bellows 332, as measured and reported by second pressure sensor 358. In this way, modulation of the respective lift control valve 350 and grasp control valve 354, the amount of vacuum supplied to the vacuum lifting system 314 to provide the lift assistance necessary to maintain operation of the programmable motion device 112 within the maximum threshold for lifting capacity, while providing the high flow vacuum necessary to grasp the object being processed. Further control of the high flow vacuum source 320 can be provided by, for example, modulating the operation speed of the high flow vacuum source 320.

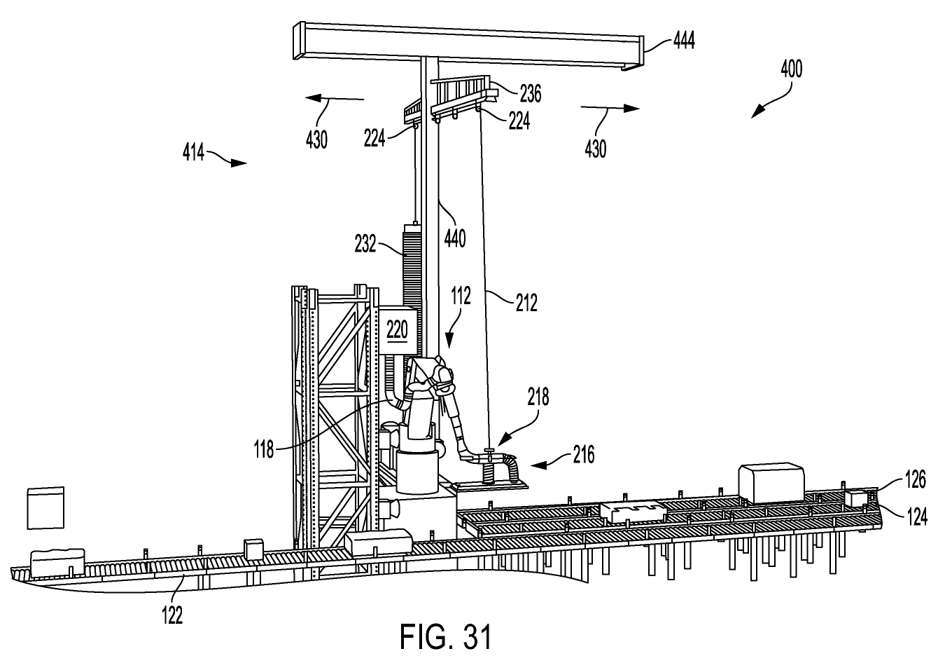

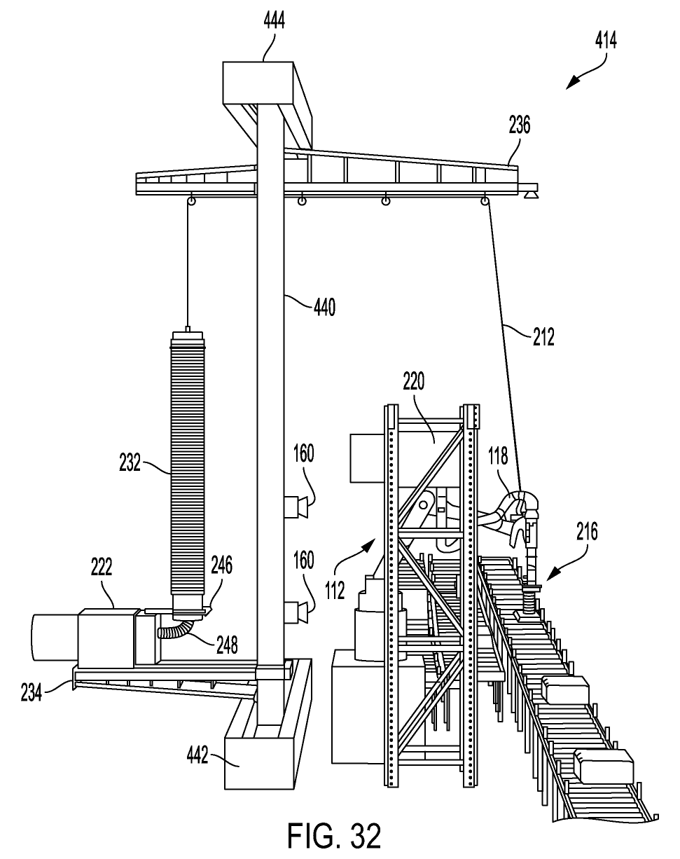

With reference to FIG. 31, an object processing system 400 in accordance with an aspect of the present invention includes a programmable motion device 112 and a vacuum lifting system 414. The programmable motion device 112 and the vacuum lifting system 414 are selectively attached and vertically anchored by virtue of a cable attachment 218 as previously described, and when attached, the programmable motion device 112 receives lift assistance from the vacuum lifting system 414 through a cable 212. The programmable motion device 112 uses a first high vacuum source 220 routed through vacuum hose 118 to a vacuum lift assist end-effector system 216, as previously described. With continued reference to FIG. 31 and with reference to FIG. 32 the vacuum lifting system 414 includes an elongated bellows 232 extending from a vacuum lifting system base 234 that is connected to the lifting cable 212 that travels through pulleys 224 along a beam 236 that is held above the programmable motion device 112 by a tower 440. The tower 440 is supported by a lower stage 442 and an upper stage 444, both of which include a movable stage of slide rails or tracks that permit motion in one dimension (shown as arrows 430). The vacuum lifting system 414 tracks the x component of motion of the vacuum lift assist end-effector system 216 as the programmable motion device 112 moves within the work environment with the z component of motion tracked by the expansion and contraction of the elongated bellows 232 tied to the lifting cable 212 when the lifting cable 212 is attached to the vacuum lift assist end-effector system 216 at the cable attachment 218. In accordance with further aspects of the invention, the upper stage 444 and the lower stage 442 may be actively driven in concert with the movements of the programmable motion device 112 to provide that the lifting cable 212 at the cable attachment 218 remains as closely aligned with the vacuum lift assist end-effector system 216 while the programmable motion device 112 moves within the work environment. When the lifting cable 212 is attached to the vacuum lift assist end-effector system 216 at the cable attachment 218, the vacuum lifting system 214 can provide lifting assistance when vacuum is applied to the elongated bellows 232 from the second high flow vacuum source 222. By modulating the flow of vacuum by the second high flow vacuum source 222 and/or controlling the flow of vacuum to the elongated bellows 232 using a vacuum flow control valve (described in further detail above with reference to FIG. 22B), the amount of lift assistance supplied by the vacuum lifting system 414 to the vacuum lift assist end-effector system 216 can be controlled.

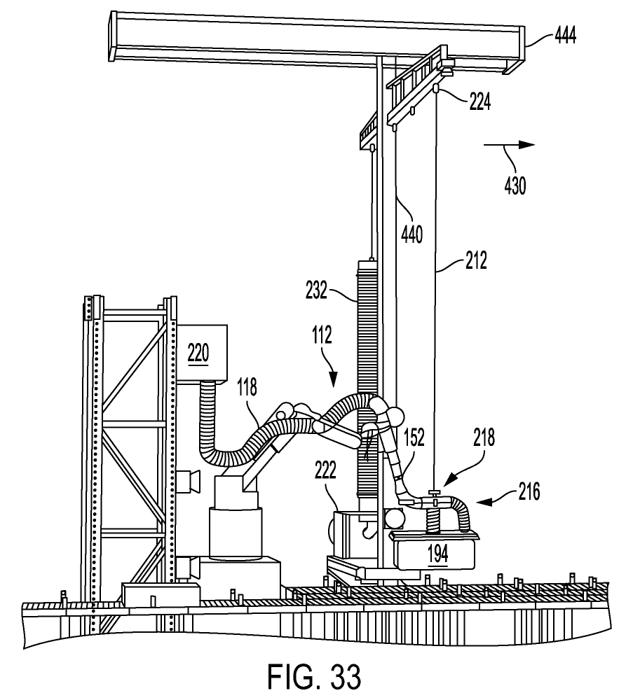

FIG. 33 depicts how an angular component to the lifting force may be induced when the programmable motion device 112 operates within the workspace due to the constrained positioning of the vacuum lifting system 414 in the y direction. As shown in FIG. 33, the tower 440, supported by the upper gantry stage 444 and the lower gantry stage 442, is moveable in the x direction, and shown translated in the direction of arrow 432, thereby eliminating or at least minimizing an angular component to the lifting force induced when the vacuum lifting system 414 is engaged to provide lifting assistance to the vacuum lift assist end-effector system 216 and the programmable motion device 112 when lifting object 194.

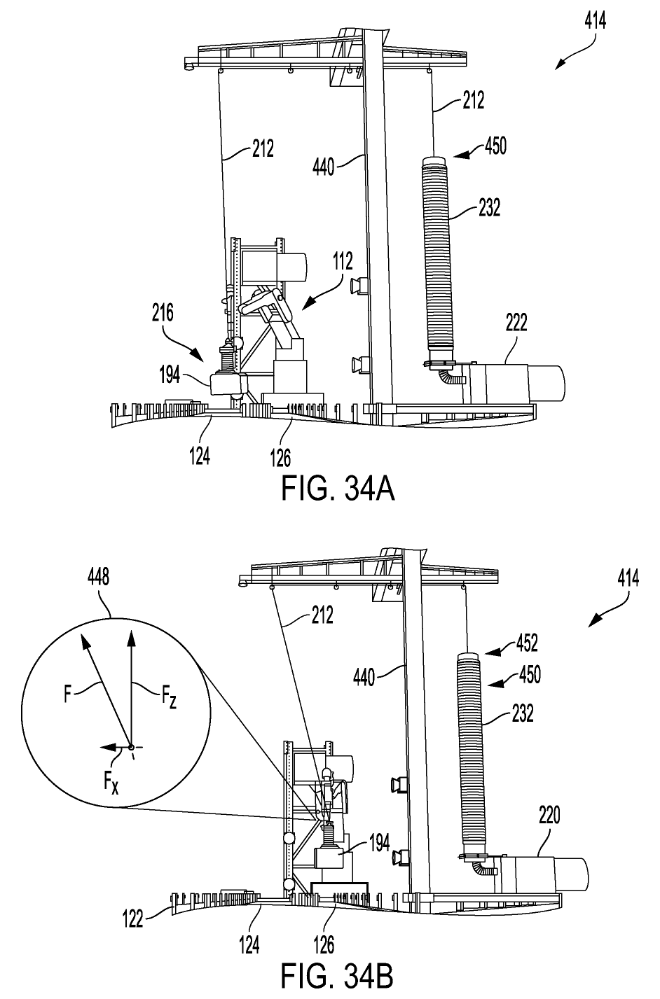

FIGS. 34A and 34B depict how the angular component to the lifting force is induced when the programmable motion device 112 operates within the workspace and the compensation required of the vacuum lifting system 414 in response. FIG. 34A depicts the object processing system 400 in the position shown in FIG. 33 but from a different perspective. The object 194 is lifted by the programmable motion device 112 with the vacuum lift assist end-effector system 216 engaged with the vacuum lifting system 414, with the elongated bellows evacuated by the second high flow vacuum source to the extent that lifting assistance is provided, with the elongated bellows 232 contracted to the extent shown at reference point 450. FIG. 34B depicts the change in conditions when the programmable motion device 112 moves to deposit the object 194 at output conveyor 126. Because of the constraint in the y direction of the vacuum lifting system 414, the lifting cable 212 must extend as shown. Force diagram 448 depicts the relationship between the lifting force “F” into a component in the z direction shown as “F z” and a component in the x direction shown as “F x.” Accordingly, the F z force component translates into a reduced lifting force with the addition of resistance induced on the programmable motion device 112 in movement in the x direction, attributed to F x. The vacuum applied to the elongated bellows 232 must be reduced accordingly, with the elongated bellows 232 extending to the reference point 452 as shown.

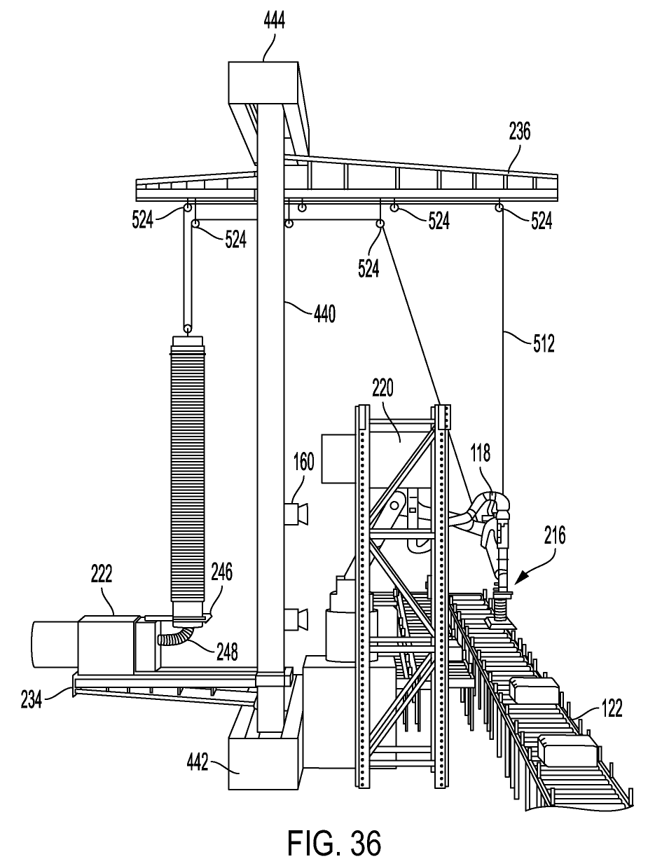

With reference to FIG. 35, an object processing system 500 in accordance with an aspect of the present invention includes a programmable motion device 112 and a vacuum lifting system 514. The programmable motion device 112 and the vacuum lifting system 514 are selectively attached by virtue of a cable attachment 218 as previously described, and when attached, the programmable motion device 112 receives lift assistance from the vacuum lifting system 514 through a cable 512. Cable 512 is arranged using a block and tackle principle using pulleys 524, including a pully 524 at the cable attachment 218 and the upper extent of the elongated bellows 232, as will be described in further detail below. The programmable motion device 112 uses a first high vacuum source 220 routed through vacuum hose 118 to a vacuum lift assist end-effector system 216, as previously described. With continued reference to FIG. 35 and with reference to FIG. 36 the vacuum lifting system 514 includes an elongated bellows 232 extending from a vacuum lifting system base 234 that is connected to the lifting cable 512 that travels through pulleys 524 along a beam 236 that is held above the programmable motion device 112 by a tower 440. The tower 440 is supported by a lower stage 442 and an upper stage 444, both of which include a movable stage of slide rails or tracks that permit motion in one dimension as previously described. The vacuum lifting system 514 tracks the x component of motion of the vacuum lift assist end-effector system 216 as the programmable motion device 112 moves within the work environment with the z component of motion tracked by the expansion and contraction of the elongated bellows 232 tied to the lifting cable 512 when the lifting cable 512 is attached to the vacuum lift assist end-effector system 216 at the cable attachment 218. In accordance with further aspects of the invention, the upper stage 444 and the lower stage 442 may be actively driven in concert with the movements of the programmable motion device 112 to provide that the lifting cable 512 at the cable attachment 218 remains as closely aligned with the vacuum lift assist end-effector system 216 while the programmable motion device 112 moves within the work environment. When the lifting cable 512 is attached to the vacuum lift assist end-effector system 216 at the cable attachment 218, the vacuum lifting system 514 can provide lifting assistance when vacuum is applied to the elongated bellows 232 from the second high flow vacuum source 222. By modulating the flow of vacuum by the second high flow vacuum source 222 and/or controlling the flow of vacuum to the elongated bellows 232 using a vacuum flow control valve (described in further detail above with reference to FIG. 22B), the amount of lift assistance supplied by the vacuum lifting system 514 to the vacuum lift assist end-effector system 216 can be controlled.

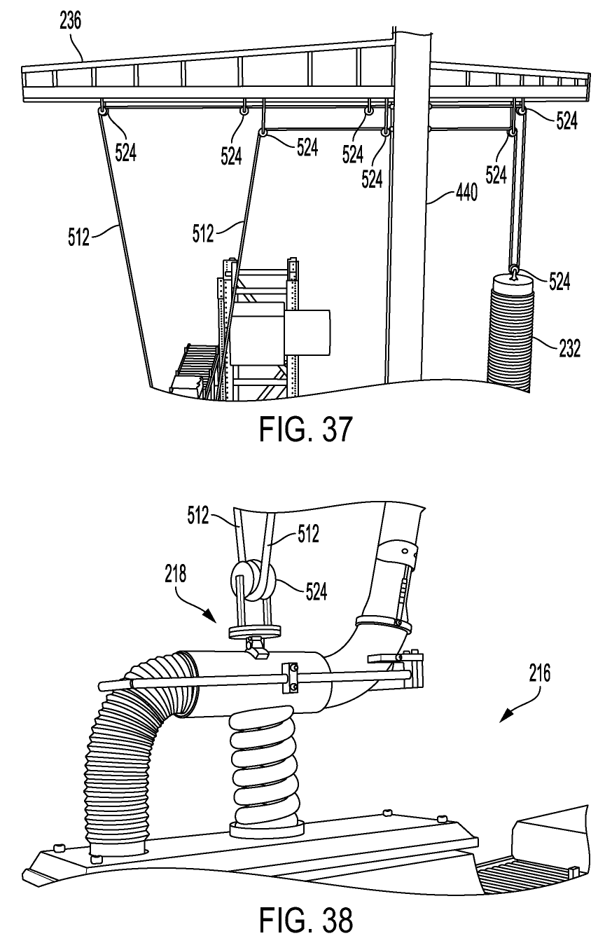

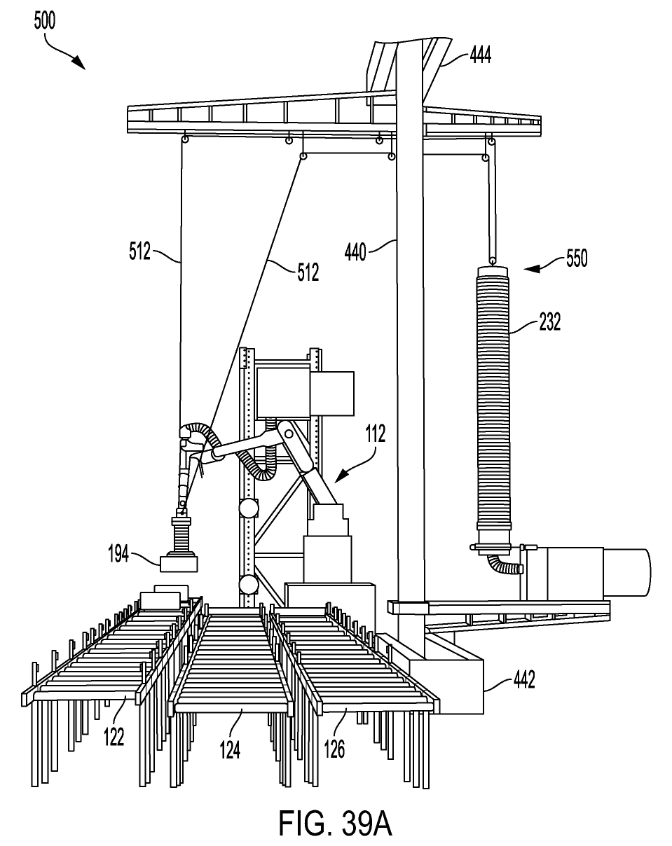

FIG. 37 depicts the arrangement of pulleys 524 on the beam 236 where the block and tackle principle applies so that each segment of lifting cable 512 carries half the load. When a lifting force is applied to the pulley 524 at the top of the elongated bellows 232 by evacuation, the tension on the lifting cable 524 is shared between each segment. Similarly, with respect to FIG. 38, the pulley 524 at cable attachment 218 on vacuum lift assist end-effector system 216 (as previously described), the lifting force applied to the pulley 524 is shared equally with each side of the lifting cable 524.

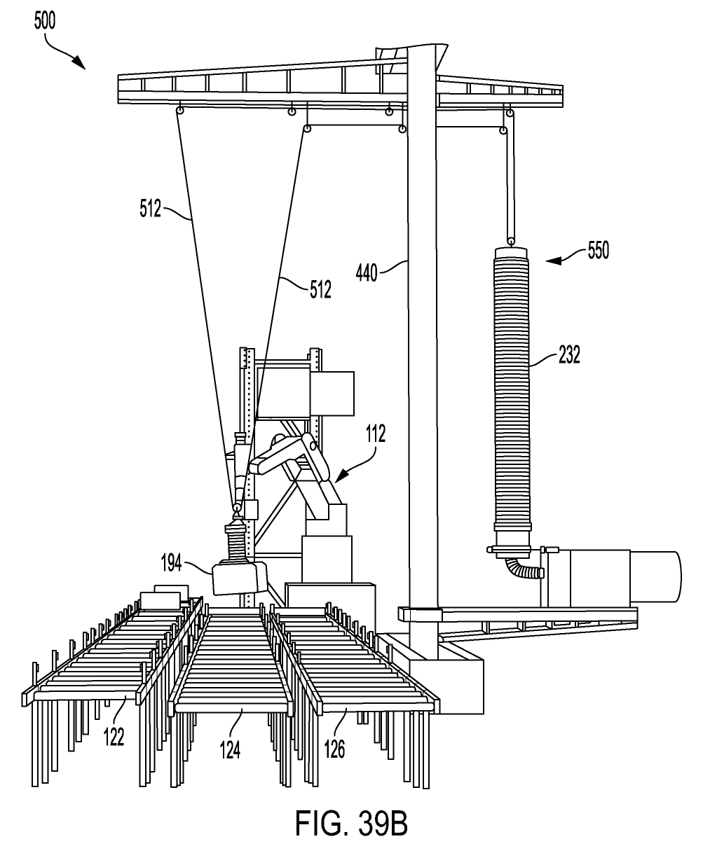

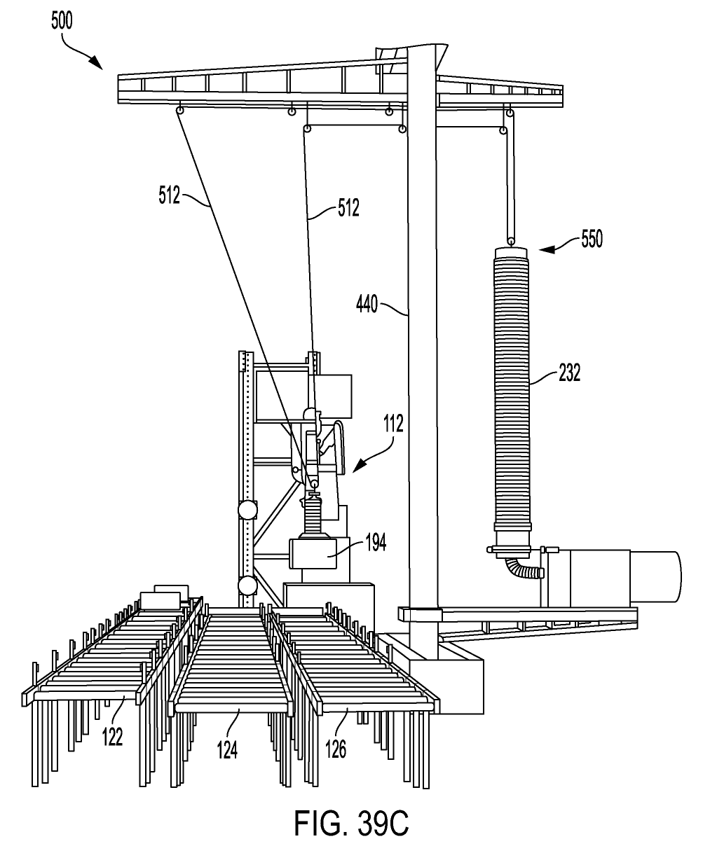

FIGS. 39A, 39B, and 39C depict a sequence of the programmable motion device 112 grasping object 194 from input conveyor 122 (FIG. 39A), moving object 194 over output conveyor 124 (FIG. 39B) and finally moving object 194 over output conveyor 126 (FIG. 39C). Each segment of lifting cable 512 shares the lifting force equally, and while not eliminating the horizontal F x component seen as resistance by the programmable motion device 112, the resulting horizontal F x component is effectively halved by the shared distribution of lifting force between the two segments of the lifting cable 512. Accordingly, the lift position 550 of the elongated bellows 232 is effectively maintained a constant throughout the range of motion described in the sequence of operation.

FIG. 40 depicts a functional view of the operational control system in accordance with an aspect of the present invention. As described herein above, the operation of the programmable motion device 112 and the interaction with any of the vacuum lifting system 114, 214, 314, 414, or 514 is controlled by the one or more computer processing systems 1000 described herein. The computer processing systems 1000 includes at least a processor 560 that receives inputs from various elements of the object processing system 100, 100’, 200, 300, 400, and 500, including, without limitation, inputs relating to operation and motion of the programmable motion device 112 and inputs relating to the motion and operation of the vacuum lifting system 114, 214, 314, 414, or 514.

The programmable motion device 112 performs the task of moving the controlling end-effector, including any one of vacuum lift assist end-effector 116, 116’, and 216, to grasp and move objects. The related inputs include the x and y position of the end-effector 566, the z position of the end-effector 582, and the load on the end-effector 578. Sensors within the programmable motion device 112 provide vacuum flow at the end-effector 580 and vacuum pressure at the end-effector 584.

The vacuum lifting systems 114, 214, 314, 414, and 514 include a stage following system 564 to the extent the systems follow the x,y position of the end-effector of the programmable motion device 112. The processor 560 controls the stage motors at 568, including operation of the x,y linear motors (where implemented, such as in the vacuum lifting systems 214, 314, 414, and 514) or the operation of the telescoping boom 136’ (in the system 100’ of FIG. 2B) or as polar coordinates in the rotation of the tower 140 and driven trolley 134 in the vacuum lifting system 114. The processor 560 receives as feedback the x,y position of the end-effector 566 from the stage following system 564.

The vacuum lifting systems 114, 214, 314, 414, and 514 include a bellows control system 562 that effectively modulates the lifting force applied by the bellows 132, 232 as needed to not exceed the maximum threshold of the carrying capacity of the programmable motion device 112, as controlled by the processor 560. The processor 560 directs and controls the engagement/disengagement of the bellows 572 as needed to provide lift assistance. Specific routines coordinating the engagement and disengagement of the lift assistance, where such engagement and disengagement is necessary, between the programmable motion device 112 and the vacuum lifting systems 214, 314, 414, and 514. To disengage, the cable attachment 218 is disconnected (for example, by deactivating the magnetic latch at the cable attachment 218), and sufficient vacuum applied to the bellows 232 to lift the lifting cable attachment magnet 230 away from the workspace. To engage, the bellows is vented to lower the lifting cable attachment magnet 230 while the programmable motion device 112 is controlled to move the end-effector magnet 228 to make the connection.

Once engaged, the bellows control system 562, in conjunction with the control instructions from the processor 560, directs vacuum flow into the bellows to establish the lift required to assist the programmable motion device 112, or specifically, the vacuum lift assist end-effector 116, 116’, and 216. Vacuum pressure at bellows 576 is measured and passed to the processor 560. Additionally, vacuum flow at bellows 574 is measured and passed to the processor 560. The force/torque sensors on the programmable motion device and the corresponding vacuum lift assist end-effector 116, 116’, and 216.

Those skilled in the art will appreciate that numerous modifications and variations may be made to the above disclosed embodiments without departing from the spirit and scope of the present invention.

What is claimed is:

1. An object processing system comprising:
a programmable motion device having an end-effector using high flow vacuum to grasp and move an object within a workspace;
an anchor positioned above the workspace;
a lifting bellows having a first end and a second end, the first end connected to the anchor, the second end connected to the end-effector;
the lifting bellows having a high flow vacuum source supply; and
a valve between the lifting bellows and the high flow vacuum source supply to regulate an amount of lift provided to the end-effector as the lifting bellows contracts from the high flow vacuum source supply.

2. The object processing system according to claim 1, wherein the end-effector has a second high flow vacuum source different than the high flow vacuum source supply of the lifting bellows.

3. The object processing system according to claim 1, wherein the anchor further comprises:
a gantry crane comprising:
a tower that rotates about a central axis;
a beam extending out from the tower; and
a trolley traveling on the beam, the first end of the bellows connected to the trolley.

4. The object processing system according to claim 3, wherein the tower that rotates about a central axis is driven by a motor.

5. The object processing system according to claim 3, wherein the trolley traveling on the beam is driven by a motor.

6. The object processing system according to claim 1, wherein the valve is on the end-effector.

7. The object processing system according to claim 1, wherein the end-effector includes a suction cup that is magnetically attached and removable.

8. An object processing system comprising:
a programmable motion device having an end-effector using high flow vacuum to grasp and move an object within a workspace; and
a lift assistance system comprising:
a vertical support having a base and an overhead beam;
a lifting bellows having a first end and a second end, the first end connected to the base and the second end connected to a lifting cable, the lifting bellows closed at the second end, and the lifting cable also being attached to the end-effector;
a high flow vacuum source fluidically connected to the lifting bellows at the first end, the high flow vacuum source including a valve to modulate the amount of vacuum provided to the lifting bellows; and
at least two pulleys attached to the overhead beam, the pulleys supporting the lifting cable.

9. The object processing system according to claim 8, wherein the high flow vacuum source is fluidically connected to the end-effector.

10. The object processing system according to claim 9, wherein the valve modulates a vacuum flow to the end-effector.

11. The object processing system according to claim 8, wherein the vertical support includes a one-dimensional stage to translate the position of the vertical support in one dimension.

12. The object processing system according to claim 11, wherein the end-effector includes a pully through which the lifting cable is supported.

13. The object processing system according to claim 12, wherein the second end of the lifting bellows includes a pulley, through which the lifting cable is supported.

14. The object processing system according to claim 8, wherein the vertical support includes a two-dimensional stage to translate the position of the vertical support in two dimensions.

15. The object processing system according to claim 8, wherein the lifting cable is attached to the end-effector at a removable connection.

16. The object processing system according to claim 8, wherein the programmable motion device includes a rotating coupling that provides a yaw adjustment of the end-effector.

17. A method of moving heavy objects with a programmable motion device, the method comprising:
providing an end-effector with the programmable motion device, the end-effector adapted to grasp the heavy object;
providing a high flow vacuum from a high flow vacuum source to a lifting bellows, the lifting bellows providing a lift assistance to the programmable motion device; and
moving the object using the programmable motion device.

18. The method according to claim 17, wherein the step of providing the high flow vacuum to the lifting bellows is in response to a force/torque sensor on the programmable motion device where an increased flow of the high flow vacuum is provided when the force/torque sensor exceeds a threshold.

19. The method according to claim 17, wherein the step of providing the high flow vacuum to the lifting bellows is in response to a force/torque sensor on the programmable motion device where an increased vacuum pressure is provided when the force/torque sensor exceeds a threshold.

20. The method according to claim 17, further comprising moving the lifting bellows to follow the movement of the programmable motion device.
